(19) United States
(12) Patent Application Publication
(10) Pub. No.: US 2020/0082185 A1
(43) Pub. Date: Mar. 12, 2020

(54) PERIPHERY MONITORING DEVICE

(71) Applicant: AISIN SEIKI KABUSHIKI KAISHA, Kariya-shi (JP)

(72) Inventors: Kinji YAMAMOTO, Anjo-shi (JP); Kazuya Watanabe, Anjo-shi (JP)

(73) Assignee: AISIN SEIKI KABUSHIKI KAISHA, Kariya-shi (JP)

(21) Appl. No.: 16/561,285

(22) Filed: Sep. 5, 2019

(30) Foreign Application Priority Data
Sep. 6, 2018 (JP) 2018-167375

(51) Int. Cl. G06K 9/00; G08G 1/16; B60W 30/045; B60R 1/00

(52) U.S. Cl. CPC G06K 9/00812; G08G 1/168; B60R 2300/607; B60R 1/002; B60W 30/045

(57) ABSTRACT

A periphery monitoring device includes: a bird's-eye view image generation unit that generates a bird's-eye view image from a captured image obtained by imaging a periphery of a vehicle; an indicator control unit that superimposes at least one indicator of a target region indicator indicating a target region to which the vehicle is able to move, a 3D object indicator indicating a 3D object present around the vehicle, and an approaching object indicator indicating an approaching object approaching the vehicle, on the bird's-eye view image in a highlighting mode; and a display adjustment unit that displays an image region based on the captured image in the bird's-eye view image on which the indicator is superimposed with at least one of a luminance value and a saturation being reduced when the vehicle is guided to the target region.

### CROSS REFERENCE TO RELATED APPLICATIONS

This application is based on and claims priority under 35 U.S.C. § 119 to Japanese Patent Application 2018-167375, filed on Sep. 6, 2018, the entire contents of which are incorporated herein by reference.

### TECHNICAL FIELD

An embodiment of this disclosure relates to a periphery monitoring device.

### BACKGROUND DISCUSSION

In the past, there is a known technique for generating, for example, a bird's-eye view image by imaging a situation around a vehicle in different directions through a plurality of imaging units (cameras) provided in a vehicle, performing image processing (for example, viewpoint conversion processing) of the plurality of captured images, and connecting the respective images. Then, a periphery monitoring device, which makes it easy to monitor a periphery of the vehicle by presenting the generated bird's-eye view image to the driver, has been proposed.

Japanese Patent No. 5321267 (Reference 1) is an example of the related art.

However, as described above, in the case of generating the bird's-eye view image, processing such as viewpoint conversion is performed on the captured image. As a result, peripheral objects (for example, other vehicles, pedestrians, and obstacles such as walls) appearing in the generated bird's-eye view image are distorted, extended, or blurred relative to the real object, and thus the image tends to provide a feeling of strangeness. Further, although a bird's-eye view image is generally generated such that the periphery centering on a host vehicle may be displayed, since only a part of the host vehicle is reflected in the image captured, it is difficult to display the host vehicle based on an image captured on the bird's-eye view image. Therefore, the host vehicle icon prepared beforehand may be displayed. In this case, on the bird's-eye view image, a well-shaped host vehicle icon and peripheral objects with distortion, extension, blurring, and the like are mixed, and the feeling of strangeness in the image becomes noticeable. Further, when the vehicle (host vehicle) moves while the driver visually recognizes such a bird's-eye view image, the host vehicle icon and peripheral objects with distortion, extension, blurring, and the like relatively move. Thus, there is a problem in that the feeling of strangeness is enhanced. Therefore, it is worthwhile to provide a periphery monitoring device capable of performing display in which the recognizability of peripheral objects can be improved while making distortion, extension, blurring, and the like of peripheral objects less noticeable even when displaying bird's-eye view images.

### SUMMARY

A periphery monitoring device according to an aspect of this disclosure includes, for example, a bird's-eye view image generation unit that generates a bird's-eye view image from a captured image obtained by imaging a periphery of a vehicle; an indicator control unit that superimposes at least one indicator of a target region indicator indicating a target region to which the vehicle is able to move, a 3D object indicator indicating a 3D object present around the vehicle, and an approaching object indicator indicating an approaching object approaching the vehicle, on the bird's-eye view image in a highlighting mode; and a display adjustment unit that displays an image region based on the captured image in the bird's-eye view image on which the indicator is superimposed with at least one of a luminance value and a saturation being reduced when the vehicle is guided to the target region.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary perspective view in which a part of a vehicle interior of a vehicle equipped with the periphery monitoring device of an embodiment is perspectively viewed;

FIG. 2 is an exemplary plan view of a vehicle equipped with the periphery monitoring device of the embodiment;

FIG. 3 is an exemplary block diagram of a configuration of a periphery monitoring system including the periphery monitoring device of the embodiment;

FIG. 4 is a block diagram exemplarily illustrating a configuration centering on a periphery monitoring unit realized by the CPU of the periphery monitoring system;

FIG. 5 is a schematic diagram illustrating, in the bird's-eye view, an example of an imaging target region imaged by each imaging unit and an overlapping region thereof;

FIG. 6 is a schematic diagram illustrating an example of a setting position of a region of interest (ROI) and luminance distribution of an original image to be processed by the periphery monitoring device according to the embodiment;

FIG. 7 is a diagram for explaining an example of a part of the luminance adjustment processing executed by the periphery monitoring device according to the embodiment, and is a schematic diagram illustrating a straight line interpolation formula corresponding to correction for correcting a luminance of the region of interest in the imaging target region in front of the vehicle to a target luminance;

FIG. 8 is a diagram for explaining a case of executing the correction based on the luminance which is set by the straight line interpolation formula of FIG. 7, and is a schematic diagram illustrating an example of change in the luminance state before and after correction of the imaging target region in front of the vehicle;

FIG. 9 is a diagram for explaining an example of a part of processing of the periphery monitoring device according to the embodiment, and is a schematic diagram illustrating the straight line interpolation formula corresponding to correction for correcting the luminance of the region of interest of the imaging target region on the side of the vehicle to the target luminance;

FIG. 10 is a schematic diagram illustrating an example of the luminance state of the bird's-eye view image generated when the luminance correction is performed on the imaging target region around the vehicle;

FIG. 11 is an exemplary schematic diagram illustrating a state in which a bird's-eye view image shown in the first bird's-eye view display region and an actual image of the front of the vehicle are displayed on the screen of the display device in the periphery monitoring device according to the embodiment;

FIG. 12 is an exemplary schematic diagram illustrating a state in which a bird's-eye view image shown in the second bird's-eye view display region and an actual image of the front of the vehicle are displayed on the screen of the display device in the periphery monitoring device according to the embodiment;

FIG. 13 is an exemplary schematic diagram illustrating a state in which a bird's-eye view image, which is displayed by superimposing a highlighting mode indicator on a bird's-eye view image displayed with the luminance value decreased, and an actual image of the front of the vehicle are displayed on the screen of the display device in the periphery monitoring device according to the embodiment;

FIG. 14 is a diagram illustrating the display state of the display device after guidance of the vehicle is started in the periphery monitoring device according to the embodiment, and is an exemplary schematic diagram illustrating a state in which a bird's-eye view image, which is displayed by superimposing a highlighting mode indicator including an approaching object indicator on a bird's-eye view image displayed with the luminance value decreased, and an actual image of the front of the vehicle are displayed on the screen of the display device; and

FIG. 15 is a flowchart exemplarily illustrating a flow of a series of processing of displaying the bird's-eye view image and guiding the vehicle by using the periphery monitoring device according to the embodiment.

### DETAILED DESCRIPTION

Hereinafter, exemplary embodiments disclosed here will be disclosed. The configurations of the embodiments given below, and the operations, results, and effects provided by the configurations are examples. This disclosure can be realized by configurations other than the configurations disclosed in the following embodiments, and at least one of various effects based on the basic configuration and derivative effects can be obtained.

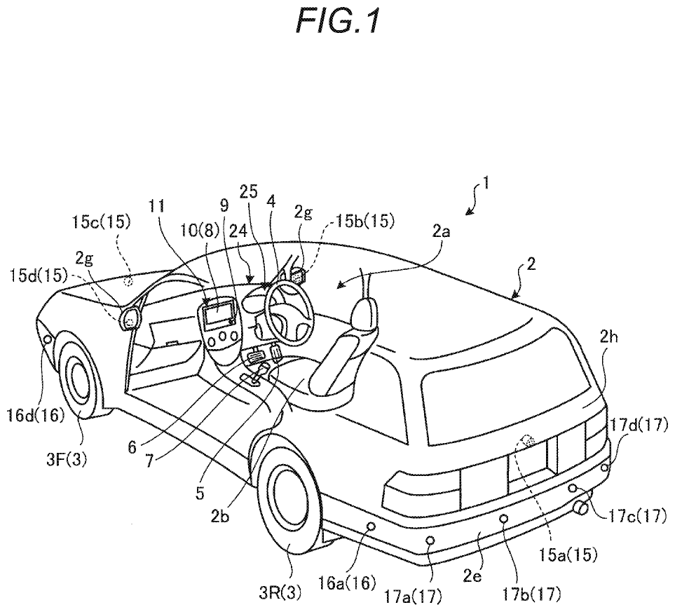

As exemplified in FIG. 1, in this embodiment, for example, a vehicle 1 equipped with a periphery monitoring device (periphery monitoring system) may be an automobile having an internal combustion engine, which is not illustrated, as a drive source, that is, an internal combustion engine automobile, and may be an automobile whose drive source is an electric motor not illustrated, that is, an electric automobile, a fuel cell automobile, or the like. Further, the vehicle 1 may be a hybrid automobile using both of them as a drive source, or may be an automobile equipped with another drive source. Furthermore, the vehicle 1 can be mounted with various speed changers, and can be mounted with various devices, such as a system or components, necessary for driving an internal combustion engine or an electric motor. Moreover, the drive system of the vehicle 1 may be that of a four-wheel drive vehicle which uses all four wheels as drive wheels by transmitting a driving force to all the four vehicle wheels 3, and may be a front wheel drive system or a rear wheel drive system. The system, number, layout, and the like of the devices involved in the drive of the vehicle wheels 3 can be set in various ways.

The vehicle body 2 constitutes a vehicle interior 2a in which an occupant not illustrated rides. A steering unit 4, an acceleration operation unit 5, a braking operation unit 6, a speed changer operation unit 7, and the like are provided in the vehicle interior 2a in a state where the units face a seat 2b of a driver as the occupant. The steering unit 4 is, for example, a steering wheel protruding from the dashboard 24. The acceleration operation unit 5 is, for example, an accelerator pedal positioned under the driver's foot. The braking operation unit 6 is, for example, a brake pedal located under the driver's foot. The speed changer operation unit 7 is, for example, a shift lever protruding from the center console. The steering unit 4, the acceleration operation unit 5, the braking operation unit 6, the speed changer operation unit 7, and the like are not limited to these.

In the vehicle interior 2a, a display device 8 as a display output unit and an audio output device 9 as an audio output unit are provided. The display device 8 is, for example, a liquid crystal display (LCD), an organic electroluminescent display (OELD), or the like. The audio output device 9 is, for example, a speaker. Further, the display device 8 is covered with a transparent operation input unit 10 such as a touch panel. The occupant can visually recognize the image displayed on the display screen of the display device 8 through the operation input unit 10. Further, the occupant is able to execute an operation input through operations such as touching, pushing, or moving of the operation input unit 10 with a finger or the like at a position corresponding to the image displayed on the display screen of the display device 8. The display device 8, the audio output device 9, the operation input unit 10, and the like are provided, for example, in the monitor device 11 located at the center of the dashboard 24 in the vehicle width direction, that is, in the lateral direction. The monitor device 11 is able to have an operation input unit, which is not illustrated, such as a switch, a dial, a joystick, or a push button. Further, an audio output device not illustrated can be provided at another position in the vehicle interior 2a different from the monitor device 11, and audio can be output from the audio output device 9 of the monitor device 11 and another audio output device. The monitor device 11 can also be used as, for example, a navigation system or an audio system.

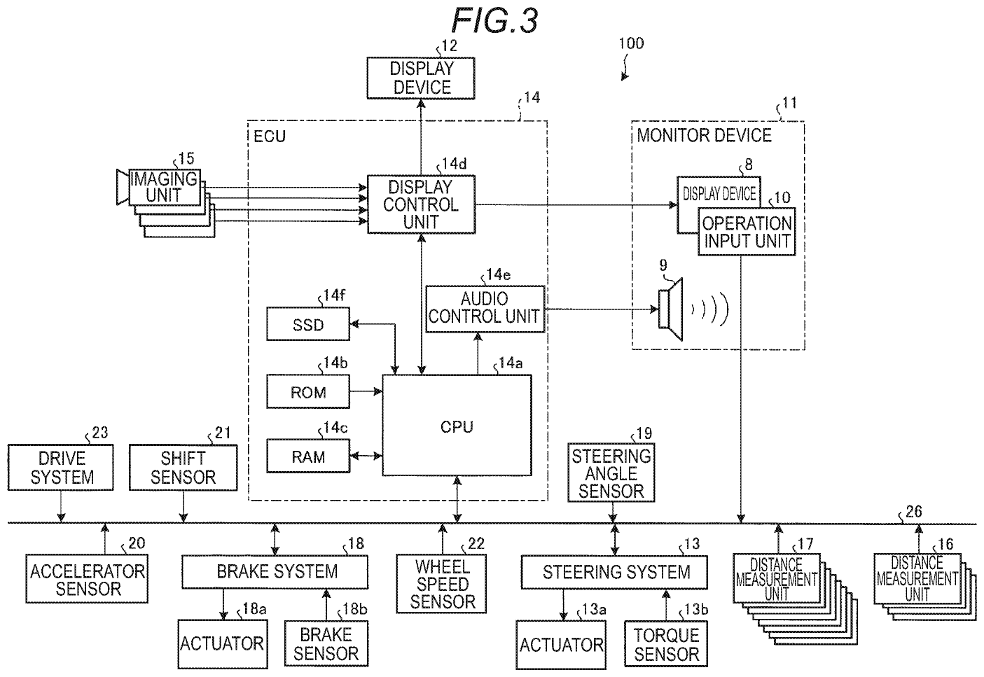

As illustrated in FIG. 3, a display device 12 different from the display device 8 is provided in the vehicle interior 2a. The display device 12 may be provided, for example, in the dashboard unit 25 (refer to FIG. 1) of the dashboard 24 and may be positioned approximately at the center of the dashboard unit 25 between the speed display unit and the rotation speed display unit. The size of the screen of the display device 12 may be smaller than the size of the screen of the display device 8. The display device 12 may display an image indicating a control state by an indicator, a mark, text information, and the like as auxiliary information when various functions such as periphery monitoring of the vehicle 1 and a parking assistance function are operating. The amount of information displayed on the display device 12 may be smaller than the amount of information displayed on the display device 8. The display device 12 is, for example, an LCD, an OELD, or the like. The information displayed on the display device 12 may be displayed on the display device 8.

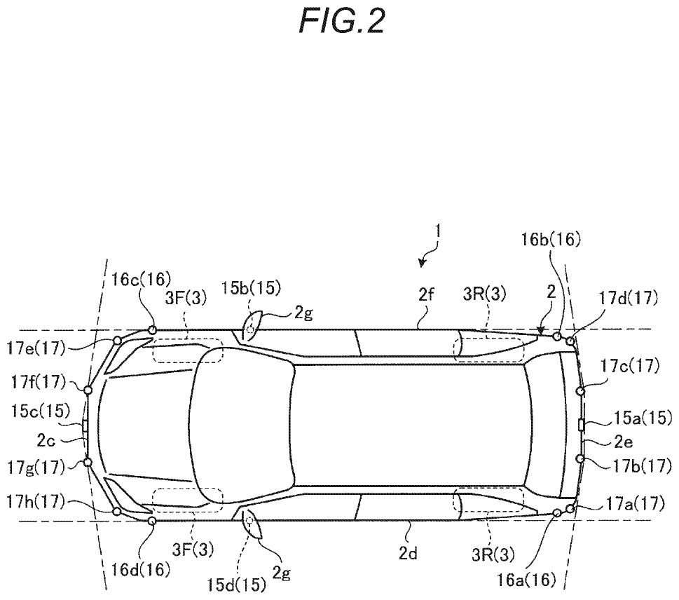

As illustrated in FIGS. 1 and 2, the vehicle 1 is, for example, a four-wheeled vehicle, and has two left and right front vehicle wheels 3F and two left and right rear vehicle wheels 3R. All of these four vehicle wheels 3 can be configured to be steerable. As illustrated in FIG. 3, the vehicle 1 has a steering system 13 that steers at least two vehicle wheels 3. The steering system 13 has an actuator 13a and a torque sensor 13b. The steering system 13 is electrically controlled by an electronic control unit (ECU) 14 or the like so as to operate the actuator 13a. The steering system 13 is, for example, an electric power steering system, a steer-by-wire (SBW) system, or the like. Further, the torque sensor 13b detects, for example, a torque that the driver gives to the steering unit 4.

As illustrated in FIG. 2, the vehicle body 2 is provided with, for example, four imaging units 15a to 15d as the plurality of imaging units 15. The imaging unit 15 is, for example, a digital camera that incorporates an imaging element such as a charge coupled device (CCD) or a CMOS image sensor (CIS). The imaging unit 15 can output moving image data (captured image data) at a predetermined frame rate. Each of the imaging units 15 has a wide-angle lens or a fish-eye lens, and is able to image a range of, for example, 140° to 220° in the horizontal direction. In addition, the optical axis of the imaging unit 15 may be set obliquely downward. Therefore, the imaging unit 15 is able to set targets of interest, sequentially capture images of the targets of interest, and may output the images as captured image data. The targets of interest includes a road surface on which the vehicle 1 is able to move, a non-3D object such as a stop line, a parking frame line, or a division line attached to the road surface, and an object present around the vehicle 1 (a 3D object, an approaching object, or the like such as a wall, a tree, a person, a bicycle, or a vehicle may be referred to as an “obstacle” in some cases).

The imaging unit 15a is located, for example, at the rear end 2e of the vehicle body 2, and is provided on the lower wall portion of the rear window of the door 2h of the rear hatch. The imaging unit 15b is, for example, located at the right end 2f of the vehicle body 2 and provided on the right side door mirror 2g. The imaging unit 15c is located, for example, on the front side of the vehicle body 2, that is, on the end 2c on the front side in the vehicle front-rear direction, and is provided on a front bumper, a front grill, or the like. The imaging unit 15d is, for example, located on the left side of the vehicle body 2, that is, on the end 2d on the left side in the vehicle width direction, and is provided on the left side door mirror 2g. The ECU 14 executes arithmetic processing and image processing based on the captured image data obtained by the plurality of imaging units 15 so as to generate an image with a wider viewing angle or generate a virtual bird's-eye view image when the vehicle 1 is viewed from the top. In addition, in the captured image data (image) captured by each imaging unit 15, overlapping regions overlapping with each other are provided such that a missing region does not occur when the images are joined. For example, an end region of captured image data (front image) captured by the imaging unit 15c on the left side in the vehicle width direction overlaps with an end region of captured image data obtained by the imaging unit 15d on the front side in the vehicle front-rear direction. In addition, processing of joining (combining) two images is performed. In a similar manner, overlapping regions are provided for the front image and the right side image, the left side image and the rear image, and the rear image and the right side image, and processing of joining (combining) two images is performed.

As illustrated in FIGS. 1 and 2, the vehicle body 2 is provided with, for example, four distance measurement units 16a to 16d and eight distance measurement units 17a to 17h as a plurality of distance measurement units 16 and 17. The distance measurement units 16 and 17 are, for example, sonars that emit ultrasonic waves and catch the reflected waves. The sonar may also be referred to as a sonar sensor, an ultrasonic detector, or an ultrasonic sonar. In this embodiment, the distance measurement units 16 and 17 are provided at low positions of the vehicle 1 in the vehicle height direction, for example, at front and rear bumpers. In addition, the ECU 14 is able to measure the presence or absence of an object such as an obstacle located around the vehicle 1 and the distance to the object based on the detection results of the distance measurement units 16 and 17. That is, the distance measurement units 16 and 17 each are an example of a detection unit that detects an object. The distance measurement unit 17 can be used, for example, to detect an object at a relatively short distance, and the distance measurement unit 16 can be used, for example, to detect an object at a relatively long distance farther than the distance measurement unit 17. Further, the distance measurement unit 17 can be used, for example, to detect an object in front of and behind the vehicle 1, and the distance measurement unit 16 can be used to detect an object on the side of the vehicle 1.

As illustrated in FIG. 3, in the periphery monitoring system 100 (periphery monitoring device), not only the ECU 14, the monitor device 11, the steering system 13, the distance measurement units 16 and 17, and the like, but also a brake system 18, a steering angle sensor 19, an accelerator sensor 20, a shift sensor 21, a vehicle wheel speed sensor 22, a drive system 23, and the like are electrically connected through an in-vehicle network 26 as a telecommunication line. The in-vehicle network 26 is configured, for example, as a controller area network (CAN). The ECU 14 is able to control the steering system 13, the brake system 18, the drive system 23, and the like by transmitting control signals through the in-vehicle network 26. Further, the ECU 14 is able to receive detection results of the torque sensor 13b, the brake sensor 18b, the steering angle sensor 19, the distance measurement units 16 and 17, the accelerator sensor 20, the shift sensor 21, the vehicle wheel speed sensor 22, and the like, operation signals of the operation input unit 10 and the like, through the in-vehicle network 26.

The ECU 14 has, for example, a central processing unit (CPU) 14a, a read only memory (ROM) 14b, a random access memory (RAM) 14c, a display control unit 14d, an audio control unit 14e, a solid state drive (SSD, flash memory) 14f, and the like. The CPU 14a is able to execute, for example, arithmetic processing and control of image processing relating to an image displayed on the display devices 8 and 12. Further, the CPU 14a executes distortion correction processing for correcting distortion by performing arithmetic processing and image processing on captured image data (data of a curved image) of a wide-angle image obtained by the imaging unit 15, and creates a bird's-eye view image (periphery image) in which a host vehicle icon indicating the vehicle 1 is displayed at, for example, a central position based on the captured image data obtained by the imaging unit 15. Thereby, the CPU 14a is able to cause the display device 8 to display the bird's-eye view image. The CPU 14a is able to change the area of the visual field (display region) by changing the height of the viewpoint of the bird's-eye view image to be generated, for example, in accordance with the processing step of the image processing for the periphery monitoring. Further, the CPU 14a is able to execute tone adjustment processing (for example, brightness adjustment processing) of the bird's-eye view image. The CPU 14a is able to execute travel assistance by identifying a division line or the like indicated on the road surface around the vehicle 1 from the captured image data provided from the imaging unit 15. For example, the CPU 14a detects (extracts) a division (for example, a parking division line or the like), sets a target region (for example, a target parking region) to which the vehicle 1 is able to move, and acquires a guidance route for guiding the vehicle 1 to the target region. Thereby, the CPU 14a is able to execute guidance control for guiding the vehicle 1 to the target region in a fully automatic, semi-automatic, or manual manner (for example, an operation guide using an audio).

The CPU 14a is able to read a program installed and stored in a non-volatile storage device such as the ROM 14b and execute arithmetic processing in accordance with the program. The RAM 14c temporarily stores various kinds of data used in the calculation in the CPU 14a. Further, the display control unit 14d mainly executes composition of image data displayed on the display device 8 and the like, in the arithmetic processing in the ECU 14. Further, the audio control unit 14e mainly executes processing of audio data which is output from the audio output device 9, in the arithmetic processing in the ECU 14. The SSD 14f is a rewritable non-volatile storage unit, and is able to store data even when the power supply of the ECU 14 is turned off. The CPU 14a, the ROM 14b, the RAM 14c, and the like can be integrated in the same package. Further, the ECU 14 may be configured to use another logical arithmetic processor such as a digital signal processor (DSP) or a logic circuit instead of the CPU 14a. In addition, a hard disk drive (HDD) may be provided instead of the SSD 14f, and the SSD 14f and the HDD may be provided separately from the ECU 14.

The brake system 18 includes, for example, an anti-lock brake system (ABS) that suppresses the lock of the brake, an anti-slip device (ESC: electronic stability control) that suppresses the side-slip of the vehicle 1 at cornering, an electric brake system that enhances the brake force (performs a brake assist), a brake-by-wire (BBW), and the like. The brake system 18 applies a brake force to the vehicle wheel 3 and to the vehicle 1 through the actuator 18a. Further, the brake system 18 is able to execute various controls by detecting the lock of the brake, the idle rotation of the vehicle wheel 3, the sign of the side slip, and the like from the difference in rotation of the left and right vehicle wheels 3. The brake sensor 18b is, for example, a sensor that detects the position of the movable portion of the braking operation unit 6. The brake sensor 18b can detect the position of the brake pedal as the movable portion. The brake sensor 18b includes a displacement sensor. The CPU 14a is able to calculate the braking distance from the current vehicle speed of the vehicle 1 and the magnitude of the brake force calculated based on the detection result of the brake sensor 18b.

The steering angle sensor 19 is, for example, a sensor that detects the amount of steering of the steering unit 4 such as a steering wheel. The steering angle sensor 19 is configured using, for example, a hall element or the like. The ECU 14 acquires the amount of steering of the steering unit 4 performed by a driver, such as the amount of steering of each vehicle wheel 3 at the time of automatic steering when executing parking assistance, from the steering angle sensor 19, and executes various controls. The steering angle sensor 19 detects the rotation angle of the rotating portion included in the steering unit 4. The steering angle sensor 19 is an example of an angle sensor.

The accelerator sensor 20 is, for example, a sensor that detects the position of the movable portion of the acceleration operation unit 5. The accelerator sensor 20 is able to detect the position of the accelerator pedal as the movable portion. The accelerator sensor 20 includes a displacement sensor.

The shift sensor 21 is, for example, a sensor that detects the position of the movable portion of the speed changer operation unit 7. The shift sensor 21 is able to detect the position of a lever, an arm, a button, or the like as a movable portion. The shift sensor 21 may include a displacement sensor or may be configured as a switch.

The vehicle wheel speed sensor 22 is a sensor that detects the amount of rotation of the vehicle wheel 3 and the number of rotations per unit time. The vehicle wheel speed sensor 22 is disposed at each vehicle wheel 3 and outputs a vehicle wheel speed pulse number indicating the number of rotations detected by each vehicle wheel 3 as a sensor value. The vehicle wheel speed sensor 22 can be configured using, for example, a hall element or the like. The ECU 14 calculates the amount of movement of the vehicle 1 and the like based on the sensor value acquired from the vehicle wheel speed sensor 22, and executes various controls. When calculating the vehicle speed of the vehicle 1 based on the sensor values of the vehicle wheel speed sensors 22, the CPU 14a determines the vehicle speed of the vehicle 1 based on the speed of the vehicle wheel 3 with the smallest sensor value among the four vehicle wheels and executes various controls. Further, when there is a vehicle wheel 3 having a sensor value larger than those of the other vehicle wheels 3 among the four vehicle wheels, for example, when there is a vehicle wheel 3 having the number of rotations in a unit period (unit time or unit distance) larger by the predetermined number than those of the other vehicle wheels 3, the CPU 14a determines that the vehicle wheel 3 is in a slip state (idle state), and executes various controls. In addition, the vehicle wheel speed sensor 22 may be provided in the brake system 18 which is not illustrated in the drawing. In that case, the CPU 14a may acquire the detection result of the vehicle wheel speed sensor 22 through the brake system 18.

The drive system 23 is an internal combustion engine (engine) system or a motor system as a drive source. The drive system 23 controls the fuel injection amount and the intake amount of the engine in accordance with the driver (user) request operation amount (for example, the amount of pressure of the accelerator pedal) detected by the accelerator sensor 20 and controls the output value of the motor. Further, regardless of the driver's operation, the output values of the engine and the motor can be controlled in cooperation with the control of the steering system 13 and the brake system 18 in accordance with the traveling state of the vehicle 1.

The configurations, arrangement, electrical connection forms, and the like of the various sensors and actuators described above are examples, and can be set (changed) in various ways.

In this embodiment, the CPU 14a generates a bird's-eye view image by performing image processing or the like on captured image data (image) captured by the imaging unit 15 and causes the display device 8 to display the bird's-eye view image. At this time, the display region of the bird's-eye view image may be changed, at least one of the luminance value and the saturation of the bird's-eye view image may be lowered and displayed, or a target region, a 3D object, an approaching object, or the like may be present around the vehicle 1. In this case, indicators that indicate those are displayed in a highlighting mode. As a result, it becomes easy to detect the relative positional relationship between the host vehicle and the target of interest such as the target region indicated by the indicator, the 3D object, or the approaching object. In addition, it becomes easy to detect (perform periphery monitoring on) the situation around the host vehicle in the bird's-eye view. In this embodiment, an example will be described in which a bird's-eye view image is provided in the manner described above when processing for automatically parking the vehicle 1 in a designated target region (for example, a target parking region) is performed.

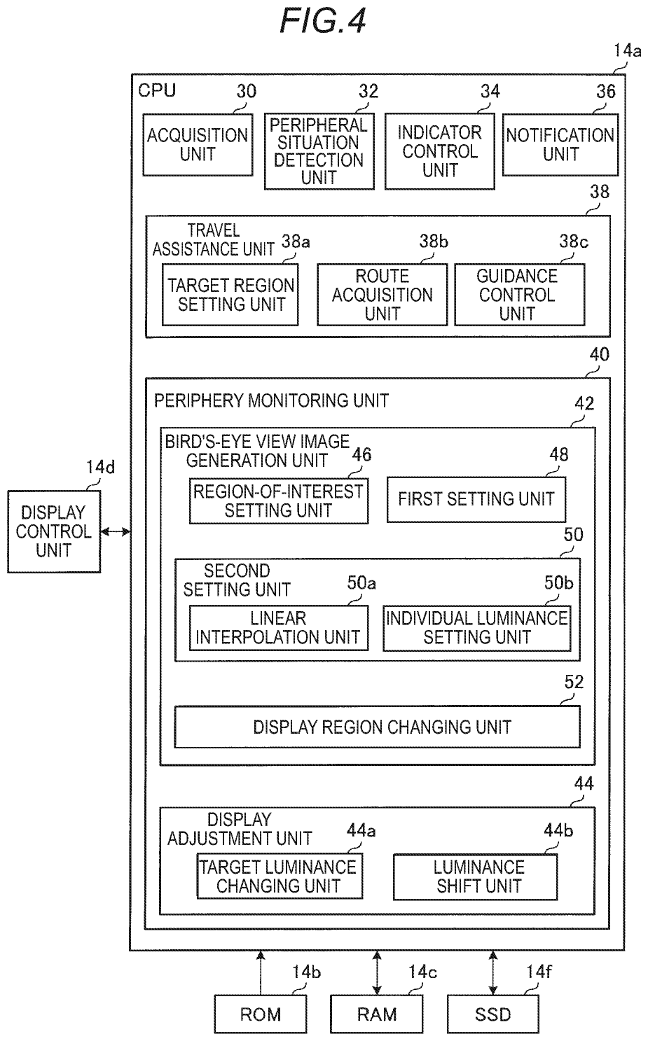

FIG. 4 is an exemplary block diagram of a configuration for realizing the parking assistance as an example of image processing of this embodiment and travel assistance for moving the vehicle 1, in the CPU 14a included in the ECU 14. It should be noted that, in the CPU 14a, the configuration other than the configuration for executing the image processing and the parking assistance of this embodiment is not illustrated in the drawing. The CPU 14a executes various types of modules for executing the parking assistance processing as described above and for executing the periphery monitoring with the bird's-eye view image. The various modules are realized by the CPU 14a reading a program installed and stored in a storage device such as the ROM 14b and executing the program. For example, as illustrated in FIG. 4, the CPU 14a includes an acquisition unit 30, a peripheral situation detection unit 32, an indicator control unit 34, a notification unit 36, a travel assistance unit 38, a periphery monitoring unit 40, and the like.

The acquisition unit 30 sequentially acquires captured image data which is obtained by imaging the periphery of the vehicle 1 and which is output by the imaging unit 15 and distance measurement data which indicates the presence or absence of the object around the vehicle 1 and the distance therefrom and which is output by the distance measurement units 16 and 17. The captured image data is mainly provided to the peripheral situation detection unit 32, the travel assistance unit 38, the periphery monitoring unit 40, and the like, and the distance measurement data is mainly provided to the peripheral situation detection unit 32, the indicator control unit 34, and the like.

The peripheral situation detection unit 32 detects the 3D object, the approaching object, and the like present around the vehicle 1 by executing known image processing, pattern matching treatment, and the like on the captured image data provided from the acquisition unit 30, and detects the target region (for example, a target parking region) by executing the detection processing of the white line and the like which were displayed on the road surface. Further, based on the distance measurement data provided from the acquisition unit 30, the peripheral situation detection unit 32 detects the presence or absence of the region (for example, a parking region) to which the 3D object, the approaching object, or the vehicle 1 is able to move, and acquires a relative positional relationship with the vehicle 1 in association with the distance information when the region is detected.

The indicator control unit 34 acquires an indicator corresponding to the 3D object, the approaching object, or the target region (for example, the target parking region) detected by the peripheral situation detection unit 32 from, for example, the ROM 14b or the SSD 14f. The acquired indicator is superimposed and displayed on the bird's-eye view image generated by the periphery monitoring unit 40. Further, when the bird's-eye view image is displayed with at least one of the luminance value and the saturation lowered as described later, the indicator control unit 34 displays the superimposed indicator in the highlighting mode as compared with that at the standard time (at the time of not executing the processing of intentionally lowering the luminance value or the saturation of the bird's-eye view image). As the display in the highlighting mode, for example, the luminance of the indicator can be increased, the indicator can be blinked, or a combination thereof can be performed.

When the bird's-eye view image is displayed, the notification unit 36 controls the selection and execution of an alarm or message to be output in a case of causing an approach of an obstacle or a deviation between a guidance route and an actual movement route during display of a message for explaining the situation and execution of travel assistance described later.

The travel assistance unit 38 controls the steering system 13, the brake system 18, the drive system 23, and the like, and executes any of fully automatic traveling for fully automatically moving the vehicle 1 to the designated target region, semi-automatic traveling for performing guiding through a part of travel control, for example, automatic control of only the steering system 13, or a manual traveling for providing an operation guide through audio or display and causing the driver to execute all travel operations.

The travel assistance unit 38 includes, for example, a target region setting unit 38a, a route acquisition unit 38b, and a guidance control unit 38c as modules for executing the travel assistance.

The target region setting unit 38a sets a target region to which the vehicle 1 is able to move based on the captured image data acquired by the acquisition unit 30. The target region setting unit 38a is able to set a target parking region in which the vehicle 1 is able to park. For example, even when the vehicle 1 travels at a low speed (for example, the vehicle speed is 5 km/h or less), the acquisition unit 30 sequentially acquires captured image data, which is obtained by imaging the periphery of the vehicle 1 from the imaging units 15a to 15d as described above, and distance measurement data about the periphery of the vehicle 1 from the distance measurement units 16 and 17. In addition, the peripheral situation detection unit 32 sequentially detects the peripheral situation of the vehicle 1. The target region setting unit 38a searches the periphery of the vehicle 1 for a candidate (in this case, a target parking region candidate) for a space, in which the vehicle 1 is able to enter, based on the peripheral situation detected by the peripheral situation detection unit 32, the vehicle width and the vehicle length of the vehicle 1, and the like. When the target parking region candidates can be searched at a plurality of locations, the target region setting unit 38a presents the candidates on a bird's-eye view image described later, and causes the driver to select a desired target parking region. When there is one target parking region candidate, the position thereof is presented. Further, the target region setting unit 38a may present a target parking region recommended from a plurality of target parking region candidates, based on the situation around the vehicle 1 (for example, the distance from the entrance of the parking lot, the parking situation around the vehicle 1, the distance from the entrance of a building when there is the building, and the like). In this case, the target region setting unit 38a may acquire information about the position where the vehicle 1 is currently present (for example, parking lot information and the like) from an external information center and select a recommended target parking region.

The route acquisition unit 38b acquires a guidance route along which the vehicle 1 can be guided from the current position to the target parking region, for example, at the minimum number of turns, based on the current position of the vehicle 1 and the target region (for example, the target parking region) which is set by the target region setting unit 38a. The guidance route may be calculated by the route acquisition unit 38b and may be acquired, or the position of the vehicle 1 and the position of the target parking region may be transmitted to an external processing device (such as a parking lot management device), and the calculated guidance route may be received and acquired by the route acquisition unit 38b. A well-known technique can be used to calculate the guidance route, and the detailed description is omitted.

When the guidance control unit 38c acquires an operation signal for requesting start of guidance of the vehicle 1 through the operation input unit 10 or the like, the guidance control unit 38c guides the vehicle 1 to the target region (target parking region) along the guidance route acquired by the route acquisition unit 38b. For example, when performing the guiding through fully automatic traveling, the guidance control unit 38c controls the steering system 13, the brake system 18, the drive system 23, and the like. Further, for example, in the case of the semi-automatic traveling in which only steering is automatically controlled, the operation amount and operation timing of the accelerator pedal and the brake pedal operated by the driver are displayed on the display device 8 and the display device 12 or are output from the audio output device 9. Similarly, in the case of the manual traveling, the display device 8 or 12 displays the steering direction and the steering amount of the steering wheel, the operation amounts and the operation timings of the accelerator pedal and the brake pedal, or outputs those from the audio output device 9.

As described above, the periphery monitoring unit 40 generates a bird's-eye view image for providing the driver and the like with the situation around the vehicle 1, and executes image processing for changing the display range of the bird's-eye view image or changing the display tone of the bird's-eye view image in accordance with the processing step at the time of executing periphery monitoring. In order to execute such image processing, the periphery monitoring unit 40 includes modules such as a bird's-eye view image generation unit 42 and a display adjustment unit 44. Further, the bird's-eye view image generation unit 42 includes modules such as a region-of-interest setting unit 46, a first setting unit 48, a second setting unit 50, and a display region changing unit 52 as detailed modules.

As described above, the imaging units 15a to 15d respectively capture a rear image, a right side image, a front image, and a left side image of the vehicle 1, in this order. Therefore, in order for the bird's-eye view image generation unit 42 to generate a bird's-eye view image, it is necessary to execute image processing for performing viewpoint conversion of each captured image (rear image, right side image, front image, left side image) and connecting adjacent regions together. Meanwhile, deviation may occur in the brightness (luminance) of the image to be captured by each imaging unit 15, depending on a mounting position and an imaging (shooting) direction of each imaging unit 15 (15a to 15d), a shooting time zone, lighting on or off of a headlight, a degree of aperture adjustment of each imaging unit 15, and the like. In this case, the bird's-eye view image generated by joining the images together may have different brightness from that of the original image. As a result, the difference in luminance may be noticeable at the joint position, and causes feeling of strangeness in the image. Therefore, when generating the bird's-eye view image, the bird's-eye view image generation unit 42 adjusts the luminance of each image. First, luminance adjustment, which is executed when images are joined and combined, will be described below.

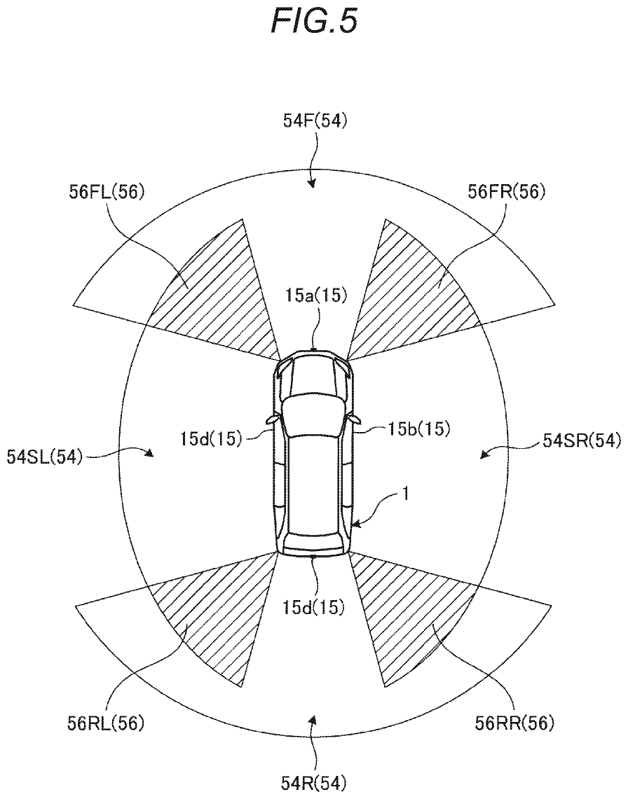

The captured image data (image) of each of the imaging units 15 (15a to 15d) acquired by the acquisition unit 30 is able to capture an image of an imaging target region 54 as illustrated in FIG. 5. Each imaging target region 54 includes an overlapping region 56 which partially overlaps with the adjacent imaging target region 54 as described above. In the imaging target region 54, the left side of an imaging target region 54F in front of the vehicle 1 in the vehicle width direction and the vehicle front side of an imaging target region 54SL on the left side of the vehicle 1 form an overlapping region 56FL. In the imaging target region 54, the vehicle rear side of the imaging target region 54SL and the left side of an imaging target region 54R behind the vehicle 1 in the vehicle width direction form an overlapping region 56RL. In the imaging target region 54, the right side of the imaging target region 54R in the vehicle width direction and the vehicle rear side of the imaging target region 54SR on the right side of the vehicle 1 form an overlapping region 56RR. In addition, in the imaging target region 54, the vehicle front side of the imaging target region 54SR and the right side of the imaging target region 54F in the vehicle width direction form an overlapping region 56FR. Each imaging unit 15 may attach an identification code for each imaging unit 15 to the captured image data in which images are captured and may output the code to the acquisition unit 30 or may attach an identification code for identifying an output source for each of the captured image data acquired by the acquisition unit 30 side.

In this embodiment, for example, when processing focusing on the imaging target region 54F is performed, one (for example, the imaging target region 54F) of a pair of imaging target regions 54 (for example, the imaging target region 54F and the imaging target region 54R) separated with the vehicle 1 interposed therebetween may be referred to as a first imaging target region. Further, one of the pair of imaging target regions 54 (for example, the imaging target region 54SL and an imaging target region 54SR) adjacent to the first imaging target region may be referred to as a second imaging target region (for example, the imaging target region 54SL). In addition, the overlapping region 56 (overlapping region 56FL) in which the first imaging target region and the second imaging target region overlap with each other may be referred to as a first overlapping region. Similarly, the other of the pair of imaging target regions 54 (for example, imaging target region 54SL and imaging target region 54SR) adjacent to the first imaging target region may be referred to as a third imaging target region (for example, imaging target region 54SR). In addition, an overlapping region 56 (overlapping region 56FR) in which the first imaging target region and the third imaging target region overlap with each other may be referred to as a second overlapping region. The pair of imaging target regions 54 separated with the vehicle 1 interposed therebetween may be, for example, an imaging target region 54SL and an imaging target region 54SR. In this case, in the second imaging target region, either the imaging target region 54F or the imaging target region 54R is one region, and the third imaging target region is the other region.

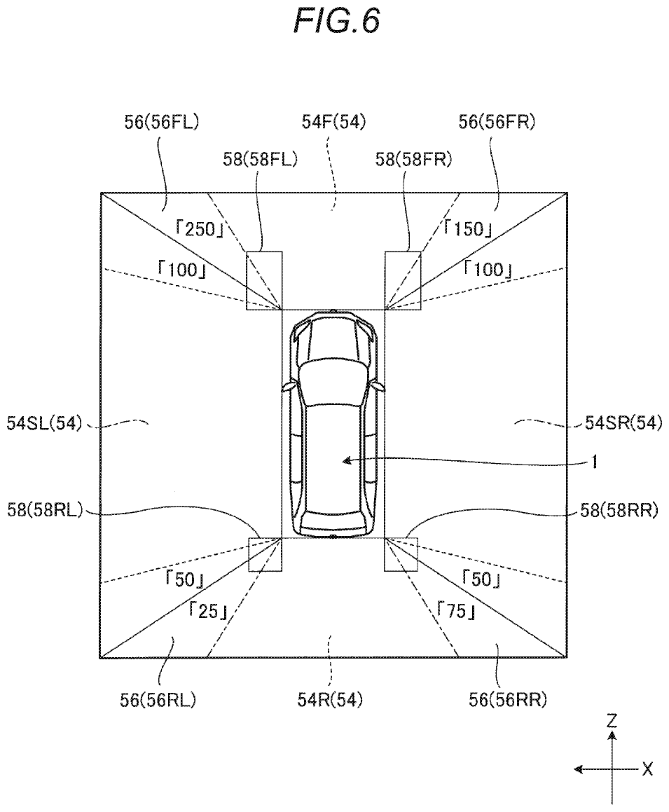

As illustrated in FIG. 6, the region-of-interest setting unit 46 sets the regions of interest 58 (58FL, 58RL, 58RR, and 58FR) to be used as references when the luminance adjustment is performed for each overlapping region 56 of the imaging target region 54 of the captured image data acquired by the acquisition unit 30. The region of interest 58 has a predetermined length in the vehicle width direction and the longitudinal direction of the vehicle 1. The luminance of the region of interest 58 as for example a rectangular region is, for example, an average value of the luminances of the pixels included in the region of interest 58. Further, when the position of the region of interest 58 is specified in this embodiment, the position is, for example, the central position of the region of interest 58 (the middle point in the vehicle width direction and the front-rear direction).

In each imaging unit 15, aperture adjustment (gain adjustment) is automatically performed at the time of imaging, and brightness adjustment (luminance adjustment) of each imaging target region 54 is performed. As a result, when many bright regions are present in the imaging target region 54, the aperture value is large, and a dark image in which the brightness is suppressed is captured. In contrast, when there are many dark regions in the imaging target region 54, the aperture value decreases, and a bright image with improved brightness is captured. Therefore, as illustrated in FIG. 6, for example, in the region of interest 58FL included in the overlapping region 56FL, a portion corresponding to the region of interest 58FL on the imaging target region 54F side and a portion corresponding to the region of interest 58FL on the imaging target region 54SL side may have the different brightness (luminances). For example, in FIG. 6, when the luminance is expressed by 256 gradations of 0 to 255 (“0” is dark and “255” is bright), for example, in the case of the region of interest 58FL included in the overlapping region 56FL, the luminance of the imaging target region 54F side is “250” which is bright, and the luminance of the imaging target region 54SL side is “100” which is darker than that of the imaging target region 54F. In addition, in FIG. 6, the numbers noted as “100” and the like shows luminances. Further, in another drawing, the numbers noted in the region of interest 58 may show luminances. The region-of-interest setting unit 46 may set the setting position of the region of interest 58 to a predetermined position, or may change the setting position in accordance with the luminance distribution of the imaging target region 54.

The first setting unit 48 corrects the luminance of the region of interest 58 by a predetermined value. For example, the first imaging target region (for example, the imaging target region 54F), which is one of the pair of imaging target regions 54 (for example, the imaging target region 54F and the imaging target region 54R) separated with the vehicle 1 interposed therebetween, will be considered. The first setting unit 48 corrects the luminance of the first region of interest (for example, the region of interest 58FL) included in the first overlapping region (for example, the overlapping region 56FL). In the first overlapping region, the first imaging target region (for example, the imaging target region 54F) overlaps with the second imaging target region (for example, the imaging target region 54SL) as one of the pair of imaging target regions 54 adjacent to the first imaging target region. Similarly, the first setting unit 48 corrects a luminance of a second region of interest (region of interest 58FR) included in the second overlapping region (for example, the overlapping region 56FR). In the second overlapping region, the first imaging target region (for example, the imaging target region 54F) overlaps with the third imaging target region (for example, the imaging target region 54SR) as the other imaging target region 54 adjacent to the first imaging target region. Similarly, the first setting unit 48 corrects luminances of a region of interest 58RL and a region of interest 58RR.

In the case of this embodiment, when the luminance of the region of interest 58 is corrected by a predetermined value, the first setting unit 48 is able to perform the correction by, for example, two kinds of methods. For example, the first setting unit 48 corrects the luminance by determining a correction value that results in the target luminance determined as a predetermined value. The first setting unit 48 corrects, for example, a target luminance (for example, “200” in 256 gradations) which is considered to be most appropriate in visibility regardless of the periphery tone environment derived in advance by experiment or the like, by using a correction value that results in the luminance of the region of interest 58.

When the first setting unit 48 calculates target luminance for correcting the luminance of the region of interest 58 included in the imaging target region 54, the first setting unit 48 adds an adjustment value determined as a predetermined value to the target luminance, thereby uniformly increasing and correcting the luminance of the imaging target region 54. For example, in the case of the imaging target region 54F, when the luminance of the region of interest 58FL on the left side in the vehicle width direction is “150” and the luminance of the region of interest 58FR on the right side in the vehicle width direction is “100”, the target luminance is determined by using at least one luminance. For example, the average luminance of “125” of the region of interest 58FL and the region of interest 58FR is set as the target luminance. When correction is performed with this target luminance, if it is determined that the brightness of the entire imaging target region 54F is insufficient, the first setting unit 48 adds an adjustment value determined as a predetermined value. For example, the brightness of the entire imaging target region 54F is uniformly increased by adding “adjustment luminance value=50” which is an adjustment value determined in advance by experiment or the like.

The second setting unit 50 sets the luminance between the regions of interest 58 based on the respective correction values of the regions of interest 58. The second setting unit 50 includes a linear interpolation unit 50a, an individual luminance setting unit 50b, and the like as detailed modules for executing this process. For example, when the region of interest 58FL on the left side of the imaging target region 54F in the vehicle width direction is set as the first region of interest, for example, a correction value for correcting the fixed target luminance which is set by the first setting unit 48 is set as a first correction value. Similarly, when the region of interest 58FR on the right side of the imaging target region 54F in the vehicle width direction is set as the second region of interest, for example, the correction value for correcting the fixed target luminance which is set by the first setting unit 48 is set as a second correction value. In this case, the linear interpolation unit 50a generates, for example, a straight line interpolation formula (a straight line connecting the first correction value and the second correction value) for performing linear interpolation by using the first correction value and the second correction value. In addition, based on the generated linear interpolation formula (for example, a straight line interpolation formula), the luminance of the region between the two regions of interest 58 is corrected.

The slope of the straight line interpolation formula may be corrected when the slope of the straight line interpolation formula generated by the linear interpolation unit 50a is equal to or greater than a predetermined limit value. For example, when the luminance of one of the adjacent regions of interest 58 greatly deviates from the target luminance which is set by the first setting unit 48, the slope of the straight line interpolation formula generated by the linear interpolation unit 50a becomes large. As a result, for example, in the periphery of the region of interest 58, a portion darker than the region of interest 58 may be corrected to be brighter due to the influence of the correction of the luminance of the region of interest 58. As a result, correction may be performed so as to increase the luminance more than necessary, and so-called “whitening” may occur. In this case, the slope of the linear interpolation formula generated by the linear interpolation unit 50a is corrected with a preset curve. This curve has a characteristic that, for example, correction is not performed if the slope of the linear interpolation formula is smaller than the limit value and the slope is corrected to decrease if the slope is equal to or greater than a predetermined value. In addition, this curve may have a characteristic such that the slope becomes a predetermined value (fixed value) which is set in advance, when the slope becomes equal to or greater than the threshold limit value larger than the limit value.

As described above, the linear interpolation unit 50a generates a straight line interpolation formula, for example, by connecting correction values for two adjacent regions of interest 58 with a straight line. In this case, depending on the correction value, in the luminance correction of the middle part, the amount of correction may be excessively small to cause “blackening” of the image or conversely, the amount of correction may be excessively large to cause “whitening” of the image. Therefore, the linear interpolation unit 50a may calculate a first coefficient of a first γ curve as a curve expression that becomes the first target luminance with respect to the luminance of the first region of interest (for example, the region of interest 58FL). Similarly, the linear interpolation unit 50a may calculate a second coefficient of a second γ curve, which is calculated as a curve expression that becomes the second target luminance with respect to the luminance of the second region of interest (for example (region of interest 58FR). In addition, the linear interpolation unit 50a may set the luminance of the region between the first region of interest and the second region of interest in accordance with the correction value (γ curve coefficient) calculated by the linear interpolation formula by generating a linear interpolation formula (straight line interpolation formula) based on the first coefficient and the second coefficient which are calculated. In this case, the γ curve expression is a curve that necessarily includes the lowest luminance value of “0” and the highest luminance value of “255” when the luminance is expressed in 256 gradations. Therefore, by using the coefficient of the γcurve, it is possible to make blackening (excessive dark correction) and whitening (excessive bright correction) of the image unlikely to occur. As a result, it is possible to suppress lack of information such as blackening and whitening, and to generate an easily recognizable periphery image.

The individual luminance setting unit 50b sets an individual correction value for correcting the luminance of the region between the first region of interest (for example, the region of interest 58FL) and the second region of interest (for example, the region of interest 58FR), based on the linear interpolation formula (for example, straight line interpolation formula) generated by the linear interpolation unit 50a. When the linear interpolation formula generated by the linear interpolation unit 50a is a linear interpolation formula relating to the imaging target region 54F in front of the vehicle 1, the individual luminance setting unit 50b performs luminance correction similarly even on the regions in the vehicle front-rear direction in the imaging target region 54F, in accordance with the linear interpolation formula. Therefore, in the case of the imaging target region 54F, the luminance correction is performed on the regions in the vehicle front-rear direction with the same correction value (amount of correction).

Next, as a specific example, the luminance correction, which is performed when the target luminance which is set in advance as a predetermined value is set by the first setting unit 48, will be described.

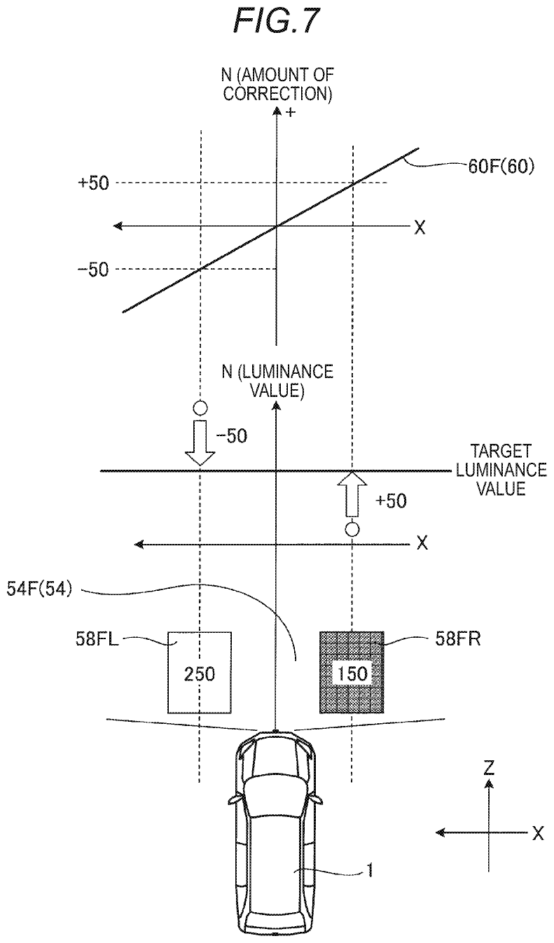

First, at the timing when the CPU 14a generates a bird's-eye view image centered on the vehicle 1 (for example, when the driver operates the operation input unit 10 so as to request start of the periphery monitoring (parking assistance)), the acquisition unit 30 acquires an image (captured image data) of the imaging target region 54 captured by the imaging unit 15. Subsequently, the region-of-interest setting unit 46 sets the region of interest 58 with respect to the imaging target region 54 of each acquired image. For example, when the luminance in the region of interest 58 of each imaging target region 54 is as illustrated in FIG. 6, the first setting unit 48 sets the target luminance (for example, “200” in 256 gradations) determined as a predetermined value for each region of interest 58, and sets a correction value for performing correction such that the luminance of the region of interest 58 becomes the target luminance (for example, “200”). FIG. 7 shows an example of correcting the luminance of the imaging target region 54F in front of the vehicle 1. In the case of the imaging target region 54F, for example, the luminance of the region of interest 58FL on the left side in the vehicle width direction (X-axis direction) is “250” in 256 gradations, and the luminance of the region of interest 58FR on the right side in the vehicle width direction is “150” in 256 gradations. On the other hand, when the target luminance which is set by the first setting unit 48 is “200” in 256 gradations, in the imaging target region 54F, as the luminance value M, a correction value of “−50” is set for the region of interest 58FL, and a correction value of “+50” is set for the region of interest 58FR.

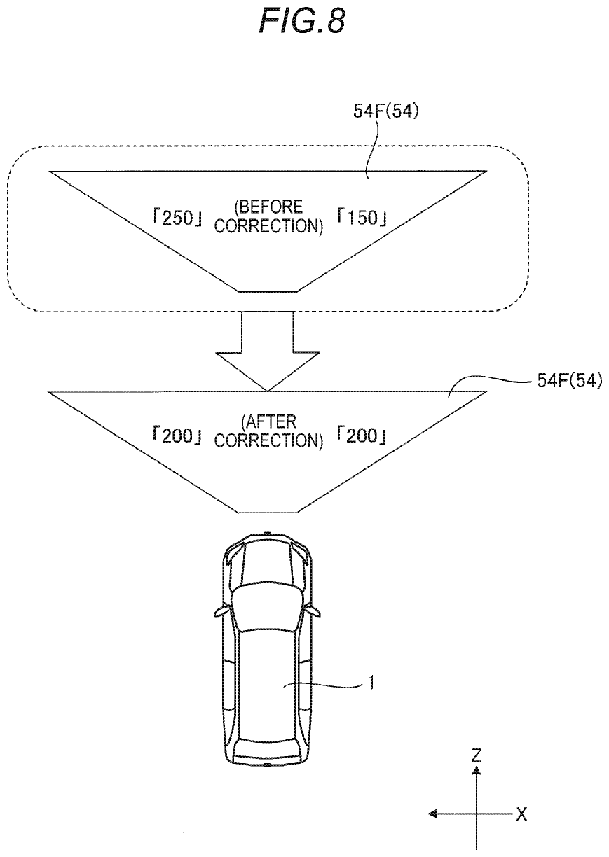

The linear interpolation unit 50a generates a straight line interpolation formula 60 (60F) by using the correction value (N=−50) of the region of interest 58FL and the correction value (N=+50) of the region of interest 58FR which are set by the first setting unit 48. As a result, the amount of correction of luminance in the vehicle width direction (X-axis direction) between the region of interest 58FL and the region of interest 58FR is indicated by the straight line interpolation formula 60F. In addition, the individual luminance setting unit 50b corrects (sets) the luminance of the region between the region of interest 58FL and the region of interest 58FR based on the generated correction value (individual correction value) calculated by the straight line interpolation formula 60F. Similarly, in the imaging target region 54F, the luminance of the region in the vehicle front-rear direction (Z-axis direction) is set (corrected) with the same correction value. As a result, as illustrated in FIG. 8, in the imaging target region 54F before correction, the luminance of the left side in the vehicle width direction (portion of the region of interest 58FL) is corrected to become dark, for example, from “250” to “200”, and the luminance of the right side in the vehicle width direction (portion of the region of interest 58FR) is corrected so as to become bright, for example, from “150” to “200”.

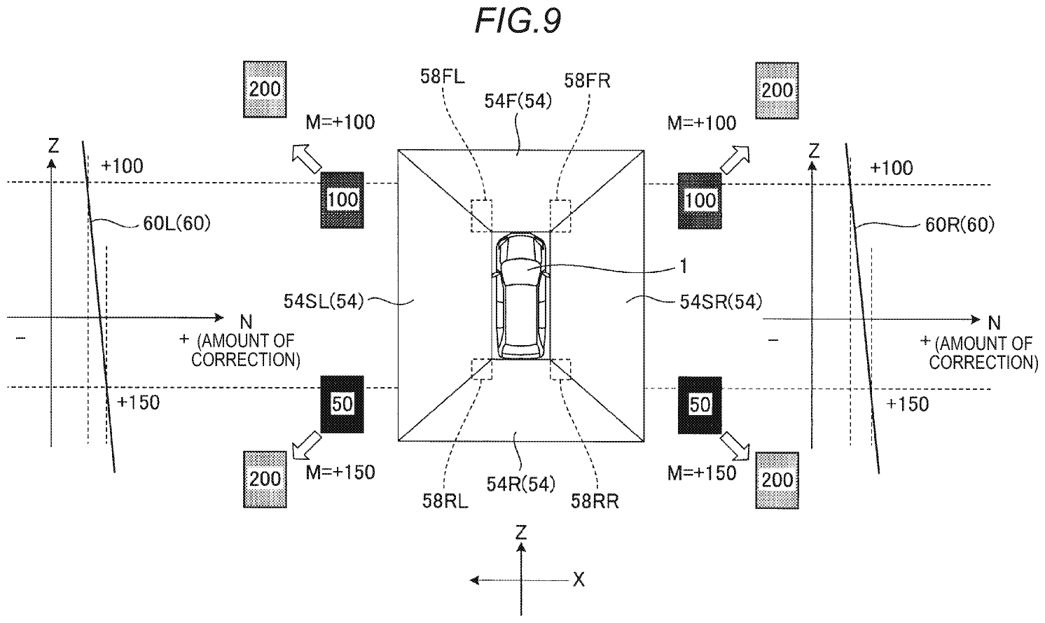

The CPU 14a executes the above-described correction processing on the entire screen. For example, the region-of-interest setting unit 46, the first setting unit 48, and the second setting unit 50 execute the same processing as described above on the imaging target region 54R behind the vehicle 1. As a result, as illustrated in FIG. 9, in the imaging target region 54R before correction, the luminance of the left side in the vehicle width direction (portion of the region of interest 58RL) is corrected to become bright from “50” to “200”, and the luminance of the right side in the vehicle width direction (portion of the region of interest 58RR) is corrected so as to become bright from “50” to “200”.

Similarly, as illustrated in FIG. 9, the region-of-interest setting unit 46, the first setting unit 48, and the second setting unit 50 each perform the same correction on the imaging target region 54SL on the left side of the vehicle 1 and the imaging target region 54SR on the right side of the vehicle 1. For example, in the case of the imaging target region 54SL, the luminance of the region of interest 58FL on the front side in the vehicle front-rear direction (Z-axis direction) is “100” in 256 gradations, and the luminance of the region of interest 58RL on the rear side is “50” in 256 gradations. On the other hand, when the target luminance which is set by the first setting unit 48 is “200” in 256 gradations, in the first setting unit 48, as the luminance value M, a correction value of “+100” is set for the region of interest 58FL, and a correction value of “+150” is set for the region of interest 58RL on the rear side. The linear interpolation unit 50a generates a straight line interpolation formula 60L by using the correction value (N=+100) of the region of interest 58FL and the correction value (N=+150) of the region of interest 58RL which are set by the first setting unit 48. Similarly, in the case of the imaging target region 54SR, the luminance of the region of interest 58FR on the front side in the vehicle front-rear direction (Z-axis direction) is “100” in 256 gradations, and the luminance of the region of interest 58RR on the rear side is “50” in 256 gradations. On the other hand, when the target luminance which is set by the first setting unit 48 is “200” in 256 gradations, in the first setting unit 48, as the luminance value M, a correction value of “+100” is set for the region of interest 58FR, and a correction value of “+150” is set for the region of interest 58RR on the rear side. The linear interpolation unit 50a generates a straight line interpolation formula 60R by using the correction value (N=+100) of the region of interest 58FR and the correction value (N=+150) of the region of interest 58RR which are set by the first setting unit 48.

As a result, the amount of correction of luminance in the vehicle front-rear direction (Z-axis direction) between the region of interest 58FL and the region of interest 58RL in the imaging target region 54SL is indicated by the straight line interpolation formula 60L, and an individual amount of correction of luminance in the vehicle front-rear direction (Z-axis direction) between the region of interest 58FR and the region of interest 58RR in the imaging target region 54SR is indicated by the straight line interpolation formula 60R. In addition, based on the straight line interpolation formula 60L, the individual luminance setting unit 50b corrects the luminance of the region between the region of interest 58FL and the region of interest 58RL and the luminance of the region in the vehicle width direction (X-axis direction) in the imaging target region 54SL, with the same individual amount of correction. Further, based on the straight line interpolation formula 60R, the individual luminance setting unit 50b corrects the luminance of the region between the region of interest 58FR and the region of interest 58RR and the luminance of the region in the vehicle width direction (X-axis direction) in the imaging target region 54SR, with the same individual amount of correction.

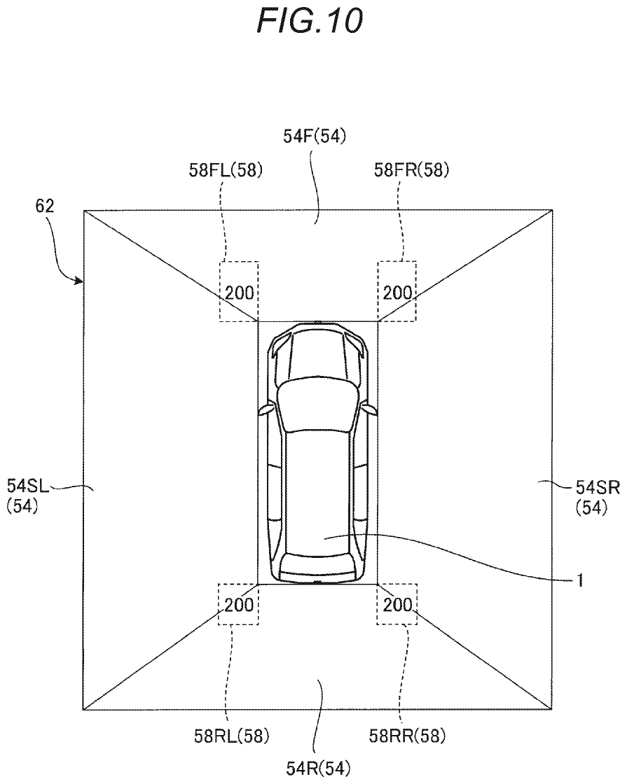

When the correction processing is completed for all the images (the imaging target region 54F, the imaging target region 54R, the imaging target region 54SL, and the imaging target region 54SR), the CPU 14a generates a bird's-eye view image obtained by joining the respective images, and updates the bird's-eye view image by causing the display device 8 to display the bird's-eye view image and repeating the same image processing in the next processing period. In this case, as illustrated in FIG. 10, the luminance of each region of interest 58 (58FL, 58RL, 58RR, and 58FR) becomes “200” in 256 gradations. As a result, it is possible to generate a bird's-eye view image 62 which is obtained by smoothly joining the imaging target regions 54 (54F, 54SL, 54R, and 54SR). In addition, since the straight line interpolation formula 60 also corrects the luminance between the regions of interest 58, generation of the excessively bright portion or the excessively dark portion is suppressed. As a result, it becomes easy to recognize the image content in any portion of the bird's-eye view image 62.

Returning to FIG. 4, the display region changing unit 52 changes the area of the display region of the generated bird's-eye view image in accordance with the processing step at the time of executing the periphery monitoring. For example, when the target region setting unit 38a presents a plurality of target parking region candidates in order to park the vehicle 1 in the target parking region, it is necessary to generate a bird's-eye view image having a wider view, that is, a bird's-eye view image of which the viewpoint position at the time of viewpoint conversion is set to be a higher position. Further, when a target parking region for parking the vehicle 1 is set and the vehicle 1 is guided to the target parking region, it is desirable to generate a bird's-eye view image including the display region capable of displaying both the guidance route acquired by the route acquisition unit 38b and the set target parking region. Therefore, the display region changing unit 52 changes the area of the display region of the bird's-eye view image between the first bird's-eye view display region (first bird's-eye view image) of the predetermined range centered on the vehicle 1 and the second bird's-eye view display region (second bird's-eye view image) wider than the first bird's-eye view display region. In this case, the first bird's-eye view display region (first bird's-eye view image) can be set as a bird's-eye view image illustrating in detail the periphery of the vehicle 1 (for example, about 1 m to 2 m around the vehicle 1) centered on the vehicle 1 (host vehicle icon corresponding to the vehicle 1). Therefore, in the second bird's-eye view display region (second bird's-eye view image), a region larger than that is appropriately displayed. For example, the second bird's-eye view display region in the case where a plurality of target parking region candidates are presented may be wider or narrower than that in the case where both the guidance route and the target parking region are displayed. However, even in either case, the display region is wider than the first bird's-eye view display region, and the display can be performed up to a position away from the vehicle 1 that the driver wants to focus on.

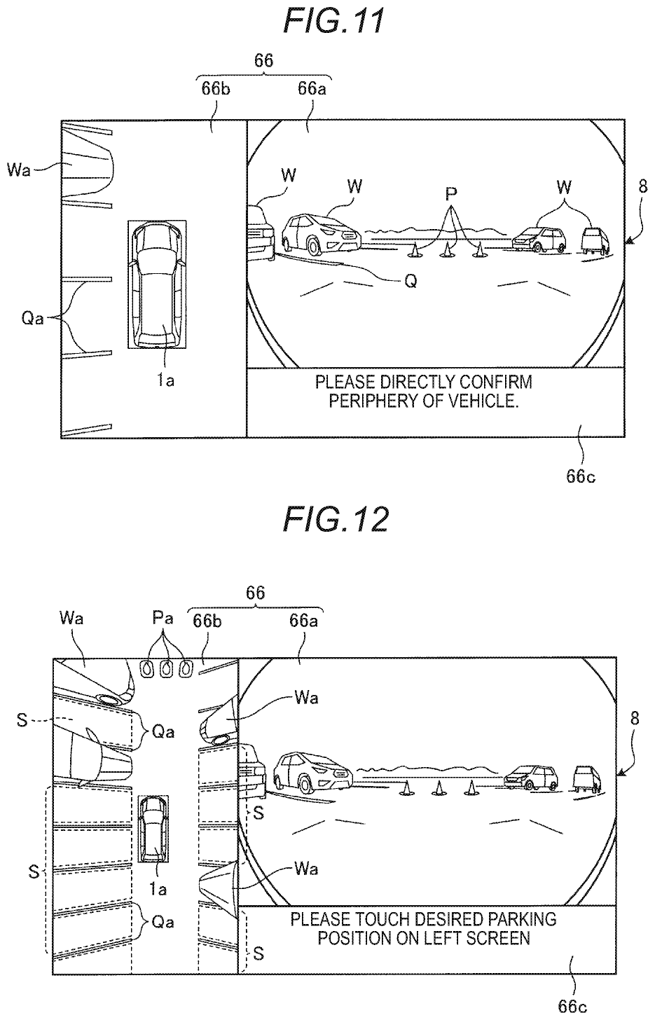

FIG. 11 shows an example of the display screen 66 displayed on the display device 8 at the time of periphery monitoring (parking assistance) request. The display screen 66 includes, for example, a two-split screen of an actual image screen 66a and a bird's-eye view image screen 66b. The actual image screen 66a is able to display, for example, an actual image based on a front image (captured front image data) of the vehicle 1 captured by the imaging unit 15a when the target region setting unit 38a searches for a candidate for a target region (target parking region). The actual image shows a plurality of other vehicles W parked around the vehicle 1 and a pylon P for easily dividing the parking lot, a parking frame line Q for dividing the parking region, and the like. Further, the bird's-eye view image screen 66b displays the first bird's-eye view image generated by the bird's-eye view image generation unit 42. The first bird's-eye view image shows the host vehicle icon 1a corresponding to the vehicle 1, the other bird's-eye-viewed vehicle Wa where the other vehicle W is shown in the bird's-eye view, and the parking division line Qa which is shown in the bird's-eye view. The host vehicle icon 1a is an icon which is prepared in advance and acquired by the indicator control unit 34 from the ROM 14b or the like. By displaying the bird's-eye view image screen 66b that displays the first bird's-eye view image, it is possible to cause the driver and the like to easily recognize that the current control state (processing step at the time of executing the periphery monitoring) is the periphery monitoring (parking assistance) request state. In this case, the notification unit 36 may display on the message screen 66c a message such as “Please directly confirm the periphery of the vehicle” or the like, which is desirable for the driver to recognize.

FIG. 12 shows a state in which the display region changing unit 52 changes the area of the display region of the bird's-eye view image in accordance with the processing step at the time of executing the periphery monitoring and the bird's-eye view image screen 66b displays the second bird's-eye view image of which the display region is wider than that of the first bird's-eye view image. In the case of FIG. 12, the display region is enlarged such that the plurality of target parking region candidates S for which the target region setting unit 38a searches can be displayed. In this case, the display region changing unit 52 determines the viewpoint height and the like of the bird's-eye view image to be generated based on the number and the position (the distance from the vehicle 1) of the target parking region candidates for which the target region setting unit 38a searches. By performing coordinate conversion in the bird's-eye view image generation unit 42, it is possible to appropriately generate a bird's-eye view image with a different display region. In addition, in FIG. 12, the display region is enlarged, such that the bird's-eye-viewed 3D object Pa in which the pylon P present outside the display region in the first bird's-eye of FIG. 11, is shown in the bird's-eye view, the other bird's-eye-viewed vehicle Wa which corresponds to the other vehicle W present outside the display region, and the like are displayed. Therefore, the driver is able to select a target parking region at a desired position among the plurality of target parking region candidates S shown in the enlarged display region by operating the operation input unit 10 or the like. In this case, the notification unit 36 may display on the message screen 66c a message indicating the currently required operation content such as “Please touch a desired parking position on the left screen”. Further, the notification unit 36 may output the same message by audio through the audio output device 9. In this case, the indicator control unit 34 may add an indicator to the target parking region candidate, other vehicles to be monitored, an obstacle, or the like, or may display the indicator in the highlighting mode as described later. In this case, the user is able to easily select a target parking region candidate and recognize an obstacle.

When the target region setting unit 38a searches for a plurality of target parking region candidates S, it is not rational to display the target parking region candidates S extremely distant from the current position of the vehicle 1. Therefore, the display region changing unit 52 may determine the area of the display region of the second bird's-eye view image display region such that the target parking region candidate S within a predetermined range (for example, within 10 m before and after the vehicle 1) is displayed based on the current position of the vehicle 1. When the target parking region candidate S is not present or is small within the range, the area of the display region may be exceptionally enlarged. Alternatively, the notification unit 36 may present, on the message screen 66c, such a message that the vehicle 1 is moved and the target parking region candidate S is searched in another region since the target parking region candidate S is not present (small) around the vehicle 1.

Meanwhile, when generating a bird's-eye view image, the imaging unit 15 provided around the vehicle 1 performs processing such as viewpoint conversion on the captured image. As a result, peripheral objects (obstacles such as other vehicles, pedestrians, and walls) shown in the generated bird's-eye view image are likely to be distorted or extended, as compared with real objects, as illustrated in FIG. 12 (which shows the other bird's-eye-viewed vehicle Wa and the bird's-eye-viewed 3D object Pa). Thus, the bird's-eye view image tends to be an image with a feeling of strangeness. Further, although the bird's-eye view image is generally generated to display the periphery of the host vehicle (vehicle 1), only a part of the host vehicle is shown in the captured image, and thus it is difficult to display the host vehicle based on the image captured on the bird's-eye view image. Therefore, the host vehicle icon 1a prepared in advance is displayed. Accordingly, on the bird's-eye view image, a well-shaped host vehicle icon 1a and peripheral objects with distortion, extension, and the like are mixed. When such a bird's-eye view image is visually recognized, the feeling of strangeness of the image due to distortion, extension or the like increases. Further, when the vehicle (host vehicle) moves, the host vehicle icon 1a and the peripheral objects with distortion, extension, and the like move relative to each other, and thus the feeling of strangeness may further increase. Furthermore, when the display region of the bird's-eye view image is enlarged, a distant portion of the display region with low resolution blurs, the jaggedness of the image becomes noticeable, and the feeling of strangeness further increases. Therefore, in the case of this embodiment, when the vehicle 1 moves in a state where the bird's-eye view image is displayed, and the bird's-eye view image is displayed with at least one of the luminance value and the saturation lowered, thereby making distortion, extension, blurring, and the like of peripheral objects unnoticeable. In the following description of this embodiment, displaying with at least one of the luminance value and the saturation lowered is referred to as “tone down mode” display. That is, the display of the tone down mode indicates displaying of the bird's-eye view image in a mode in which the luminance value or the saturation of the image region (generated from the captured image data obtained by the imaging unit 15) is decreased. In this tone down mode, while lowering the luminance value of the image region, the luminance values of the host vehicle icon 1a and the other indicators (target region indicator, approaching object indicator, approaching object indicator, and the like) to be superimposed on the bird's-eye view image is prevented from being lowered. Thus, it becomes easy to detect the positional relationship between the host vehicle and the other indicators. Furthermore, this embodiment is an example in which the host vehicle icon 1a to be superimposed on the bird's-eye view image and the other indicators (target region indicator, approaching object indicator, approaching object indicator, and the like) are highlighted.

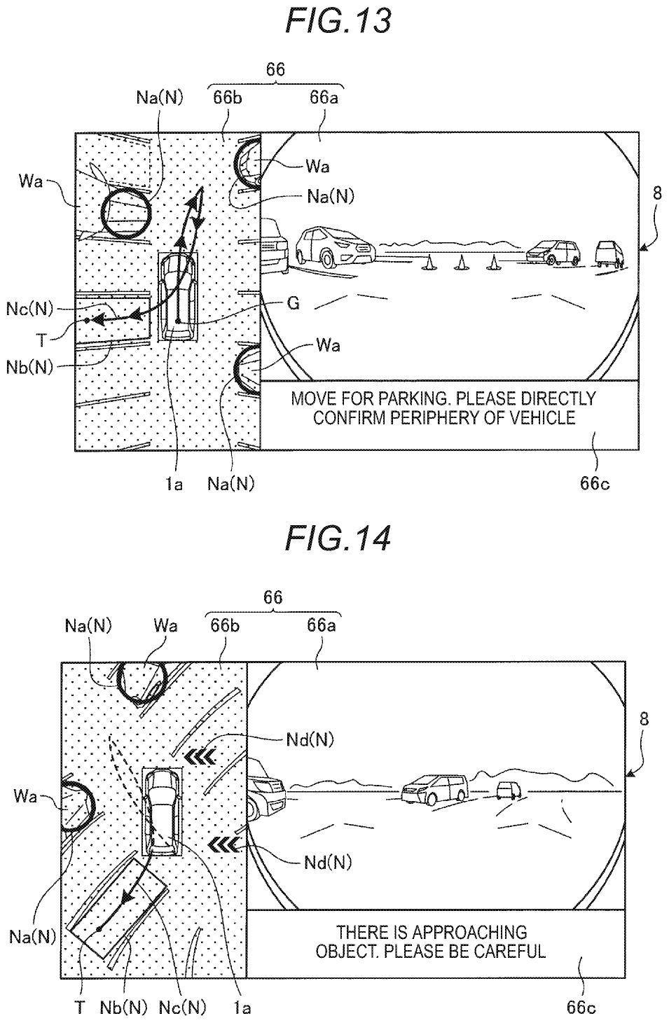

However, in this case, when the driver is unable to recognize the presence of the peripheral objects or the positional relationship with the vehicle 1, there is a possibility that the driver may feel anxious. Therefore, the indicator control unit 34 causes the peripheral objects present around the vehicle 1 detected by the peripheral situation detection unit 32 to be displayed in the highlighting mode on the bird's-eye view image using the indicator. The indicator in this case can be set as at least one of, for example, a target region indicator indicating a target region (for example, a target parking region) to which the vehicle 1 is able to move, a 3D object indicator indicating a 3D object (for example, a parked vehicle, a wall, a pillar, a pylon) present around the vehicle 1, and an approaching object indicator indicating an approaching object (for example, another vehicle or a pedestrian) approaching the vehicle 1. The indicator superimposed and displayed by the indicator control unit 34 preferably has a shape by which distortion, extension, blurring, and the like are unlikely to be recognized. The indicator can be set as an indicator N constituted by, for example as illustrated in FIG. 13, an other-vehicle mark Na having a circular shape (or a partial shape of a circular shape), a target region mark Nb having a rectangular shape (or a partial shape of a rectangular shape), or the like. In this case, regardless of the shape displayed in the bird's-eye view image, it is possible to easily recognize the presence or absence of the peripheral object and the relative distance to the host vehicle icon 1a. In another embodiment, the indicator control unit 34 may change the mode (shape) of the indicator in accordance with the type of the recognized peripheral object based on the detection result of the peripheral situation detection unit 32. For example, when the detected peripheral object is another vehicle, an indicator having a vehicle shape may be used for the detected peripheral object. When the detected peripheral object is a pedestrian, an indicator having a pedestrian shape may be used for the detected peripheral object. When the detected peripheral object is a wall, an indicator having a wall shape may be used for the detected peripheral object. When the indicator is displayed in the highlighting mode, the indicator can be displayed, for example, at a higher luminance than the luminance of the bird's-eye view image displayed in the tone down mode. Further, the highlighting effect may be further improved by using a high luminance and by changing the display mode such as blinking display.

The display adjustment unit 44 displays, in the tone down mode, the image region based on the captured image captured by each imaging unit 15, in the bird's-eye view image in which the highlighting mode indicator indicates the peripheral object as described above. When the bird's-eye view image is displayed in the tone down mode, for example, by lowering the luminance of the bird's-eye view image, it is possible to make the peripheral objects, which are distorted, extended, or blurred and are shown in the bird's-eye view image, less noticeable on the bird's-eye view image. On the other hand, even when the bird's-eye view image is displayed in the tone down mode, the peripheral objects are represented by the indicator displayed in the highlighting mode, such that it becomes easy to recognize the presence of the peripheral objects and the relative distance to the host vehicle icon 1a on the bird's-eye view image.

Returning to FIG. 4, the display adjustment unit 44 displays the bird's-eye view image (excluding the host vehicle icon 1a) in a tone down mode. For example, the bird's-eye view image can be toned down by lowering the luminance of the bird's-eye view image. However, in a case where the luminance of the bird's-eye view image generated by the bird's-eye view image generation unit 42 is originally low, when the tone is further down, the content of the bird's-eye view image screen 66b becomes unidentifiable. Even in a case where the peripheral objects are highlighted by the indicators, there is a possibility that the driver and the like who visually recognize the bird's-eye view image may feel anxious. Therefore, the display adjustment unit 44 executes the display processing in the tone down mode when the luminance value of the bird's-eye view image is equal to or greater than the predetermined value. In other words, in a case where the luminance value of the bird's-eye view image when the periphery monitoring is requested is less than the predetermined value, the tone down processing (processing for executing the display of the tone down mode) is not performed, and the bird's-eye view image is continuously displayed at the luminance at that time. In this case, since the luminance of the bird's-eye view image is originally low, the indicators, which indicate the peripheral objects and are shown in the highlighting mode, are sufficiently noticeable, and the peripheral objects, which are present on the bird's-eye view image and have distortion, extension, blurring, and the like, are visually recognizable without the feeling of strangeness. As a result, it is possible to improve the visibility of the peripheral objects by the indicators and keep the sense of security in which the peripheral objects can be roughly detected.

When changing the tone down mode of the bird's-eye view image, the display adjustment unit 44 is able to execute the processing by, for example, two kinds of methods. For example, the target luminance changing unit 44a is able to execute the display processing of the tone down mode such that the average luminance value of the bird's-eye view image becomes a predetermined target luminance value. As described above, when the bird's-eye view image generation unit 42 generates a bird's-eye view image, luminance adjustment is performed in order to suppress occurrence of a difference in luminance in a joint portion due to a difference in brightness at the time of capturing an image through each imaging unit 15. Therefore, the target luminance changing unit 44a issues an instruction about the target luminance such that the target luminance determined as the predetermined value by the first setting unit 48 becomes the luminance value after the tone is down. That is, the first setting unit 48 executes tone down processing at the same time when joining a plurality of images to generate a bird's-eye view image in which the difference in luminance is decreased and which is smoothly joined. As a result, a series of bird's-eye view image generation processing can be efficiently executed, which is capable of contributing to the reduction of the processing load.

As another method, the luminance shift unit 44b included in the display adjustment unit 44 is able to perform the tone down processing on the generated luminance value of the bird's-eye view image by using a predetermined constant value. For example, the luminance shift unit 44b is able to tone down the luminance of the generated bird's-eye view image at a constant ratio (for example, 50%). In another example, the luminance shift unit 44b is able to tone down the generated luminance of the bird's-eye view image with a constant value (for example, luminance subtraction value=−80). For example, in a case where the target luminance changing unit 44a executes the tone down processing, when the difference between the luminance of the image at the time of imaging and the target luminance which is set for the tone down processing is small, it may be difficult for the driver and the like to recognize whether or not the tone down processing is performed. On the other hand, when the luminance shift unit 44b performs the tone-down processing with a constant value, the bird's-eye view image generated by the bird's-eye view image generation unit 42 is displayed once on the display device 8, and then the bird's-eye view image in the same display region can be toned down. As a result, it is possible to make the driver and the like clearly recognize that the tone down processing has been performed. In addition, since the tone down processing is performed with a constant value, it becomes easy to identify the states before and after the tone down processing. In addition, when executing the tone down processing with a constant value, it is desirable to set a lower limit such that the tone may not be excessively down.

FIG. 13 is an example of the display screen 66 on which the bird's-eye view image screen 66b subjected to the tone down processing is displayed. In the case of FIG. 13, for the convenience of drawing, the toned down portion is expressed by adding dots. By toning down the bird's-eye view image screen 66b, the other bird's-eye-viewed vehicle Wa and the like distorted, extended, or blurred on the bird's-eye view image becomes less noticeable, and the feeling of strangeness in the whole bird's-eye view image screen 66b can be reduced. On the other hand, the indicator N, which indicates the other bird's-eye-viewed vehicle Wa and the like and which is displayed in the highlighting mode, is noticed. As a result, it becomes easy to detect the presence or absence of the other bird's-eye-viewed vehicle Wa, and it becomes easy to detect the relative positional relationship between the indicator N and the host vehicle icon 1a. FIG. 13 shows a target region mark Nb indicating the target region (target parking region), which is set by the target region setting unit 38a as the indicator N displayed in the highlighting mode, and a guidance route indicator Nc indicating the guidance route acquired by the route acquisition unit 38b. The guidance route indicator Nc is displayed to connect, along a guidance route, a guidance reference position G of the host vehicle icon 1a (for example, a position corresponding to the central position of the rear vehicle wheel shaft of the vehicle 1 in the vehicle width direction) and a guidance completion position T (the end point position of the guidance route) in the target region mark Nb. Therefore, it becomes easy for a driver or the like, who visually recognizes the bird's-eye view image screen 66b displayed in the tone down mode, to recognize an obstacle present around the vehicle 1, a movement route of the vehicle 1, a target position to which the vehicle 1 is to be guided from now, and the like, without a feeling of strangeness, through the other-vehicle mark Na, the target region mark Nb, and the guidance route indicator Nc displayed in the highlighting mode. It should be noted that, as illustrated in FIG. 12, when it is desirable for a user to determine the peripheral situation, for example, to select the target parking region candidate, the display region changing unit 52 may assist the user to easily perform a setting operation without performing the tone down processing.

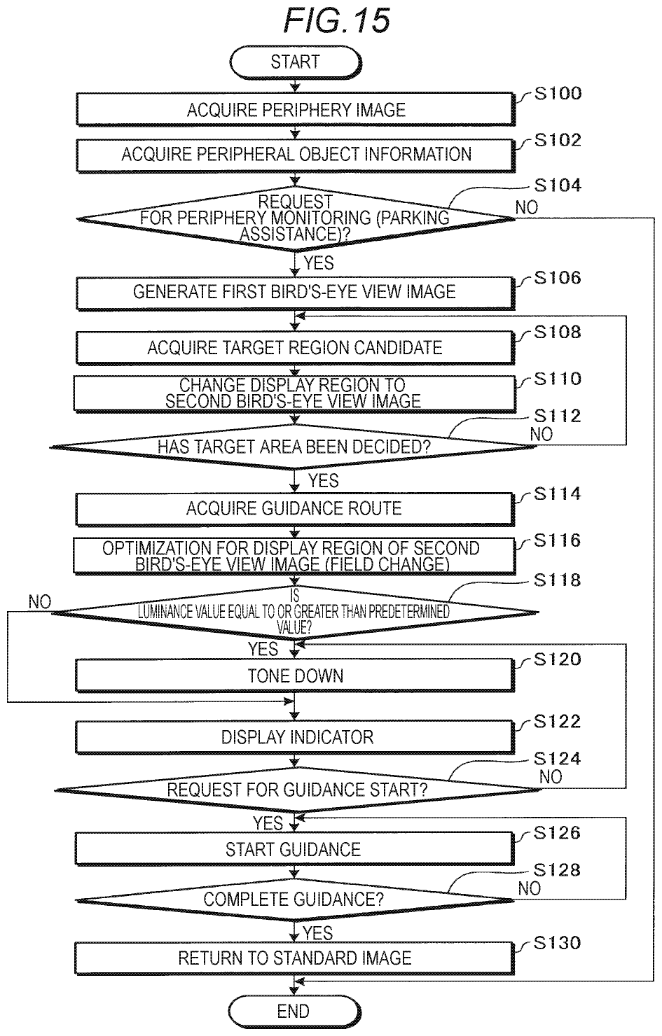

FIG. 14 is a display example of the display screen 66 (the actual image screen 66a, the bird's-eye view image screen 66b) when the periphery monitoring (parking assistance) is started and the guidance control unit 38c executes the guidance of the vehicle 1. In this case, the display of the tone down mode of the bird's-eye view image screen 66b and the display of the highlighting mode of each indicator N are kept. Further, when it is confirmed by the detection result of the peripheral situation detection unit 32 that an approaching object such as another vehicle or a pedestrian approaches the vehicle 1 during guidance and movement of the vehicle 1, the indicator control unit 34 may superimpose and display an approaching object indicator Nd (for example, an arrow mark indicating the approaching direction), which indicates presence of the approaching object, at the corresponding position on the bird's-eye view image screen 66b. In this case, the other bird's-eye-viewed vehicle Wa and the like including distortion, extension, blurring, and the like are less noticeable on the bird's-eye view image by the display of the tone down mode. Thus, it is possible to improve visibility of the approaching object indicator Nd indicating the approaching object, and it is possible to make a driver or the like unlikely to get a feeling of strangeness of distortion, extension, blurring, or the like. In addition, in the approaching object indicator Nd, the display position and the display direction are sequentially updated based on the distance measurement data detected by the peripheral situation detection unit 32. In the example illustrated in FIG. 15, when parking assistance is started through the fully automatic traveling, the image region (generated from the captured image data obtained by the imaging unit 15) of the bird's-eye view image screen 66b is displayed in the tone down mode. That is, while the guidance of the vehicle 1 is performed through the fully automatic traveling, the driving operation performed by the driver becomes unnecessary, and therefore the driver has more interests in whether or not the vehicle 1 becomes closer to the target region indicator and the positional relationship between the vehicle 1 and the obstacle than the detailed situation around the vehicle 1. Therefore, in this embodiment, while guidance of the vehicle 1 is performed through the fully automatic traveling, the luminance value of the image region is lowered such that it becomes easy to detect an indicator (the target region indicator, the 3D object indicator, the approaching object indicator, and the like) important for the driver.

The module configuration illustrated in FIG. 4 is an example, and division and integration of functions can be appropriately performed as long as the same processing can be performed.

An example of the flow of a series of processing for displaying the bird's-eye view image and guiding the vehicle 1 by the periphery monitoring device (periphery monitoring unit 40) configured as described above will be described using the flowchart in FIG. 15. In addition, the flowchart of FIG. 15 shows an example in which guidance of the vehicle 1 is performed through the fully automatic traveling.

When the power supply of the vehicle 1 is turned on, the acquisition unit 30 always acquires captured image data (periphery image) from each imaging unit 15 regardless of whether or not the vehicle 1 travels (S100). In addition, based on the captured image data acquired in S100 and the distance measurement data acquired by the acquisition unit 30 from the distance measurement units 16 and 17, the peripheral situation detection unit 32 acquires peripheral object information about the periphery of the vehicle 1 (presence or absence of the peripheral object, the distance to the peripheral object when the peripheral object is present, and the like) (S102). The bird's-eye view image generation unit 42 monitors whether or not a request operation for the periphery monitoring (parking assistance) is performed through the operation input unit 10 or the like (S104), ends this flow for the moment if the request operation is not performed (No in S104), and waits for an input of the request operation.

In S104, when the request operation for the periphery monitoring (parking assistance) is performed (Yes in S104), the bird's-eye view image generation unit 42 generates the first bird's-eye view image including the first bird's-eye view display region, based on the captured image data of each imaging unit 15 acquired by the acquisition unit 30. Then, as illustrated in FIG. 11, the display device 8 displays the actual image screen 66a and the bird's-eye view image screen 66b together (S106). Subsequently, the target region setting unit 38a acquires a target region candidate (target parking region candidate) capable of moving the vehicle 1 based on the captured image data and the distance measurement data acquired by the acquisition unit 30 (S108). In addition, when the target region candidate (target parking region candidate) is acquired, as illustrated in FIG. 12, the display region changing unit 52 changes the display region so as to generate the second bird's-eye view image having the second bird's-eye view display region including the target region candidate (target parking region candidate) (S110), and generates the second bird's-eye view image.

When a target region (target parking region) for moving the vehicle 1 is selected (determined) by the driver or the like through the operation input unit 10 (Yes in S112), the route acquisition unit 38b acquires the guidance route through which the vehicle 1 is able to most efficiently move, based on the current position of the vehicle 1 and the selected target region (S114). In contrast, when the target region (target parking region) is not selected (No in S112), the travel assistance unit 38 proceeds to S108, and the target region setting unit 38a executes the search for the target region candidate again.

In S114, when the guidance route is acquired, the display region changing unit 52 performs optimization (field change) for the display region of the bird's-eye view image screen 66b in the second bird's-eye view display region of the second bird's-eye view image where the selected target region (target parking region) and the entire guidance route can be displayed (S116).

Subsequently, when the luminance value of the second bird's-eye view image generated is equal to or greater than the predetermined value (Yes in S118), the display adjustment unit 44 executes the tone down processing of the second bird's-eye view image by using the target luminance changing unit 44a or the luminance shift unit 44b (S120). In addition, as illustrated in FIG. 13, the indicator control unit 34 superimposes at least one indicator N of the target region indicator indicating the target region (target parking region) included in the second bird's-eye view image, the 3D object indicator indicating the 3D object, and the approaching object indicator (refer to FIG. 14) indicating the approaching object which approaches the vehicle 1, on the second bird's-eye view image in a highlighting mode (S122). As a result, the other bird's-eye-viewed vehicle Wa or the like including distortion, extension, blurring, and the like becomes less noticeable on the bird's-eye view image screen 66b, and the recognizability of the indicator N displayed in the highlighting mode is improved. In S118, when the luminance value of the second bird's-eye view image is less than the predetermined value (No in S118), the processing of S120 is skipped to prevent the darkness of the bird's-eye view image from becoming extremely dark.

When the driver or the like makes a request for guidance start through the operation input unit 10 or the like (Yes in S124), the guidance control unit 38c starts guidance of the vehicle 1 by cooperatively controlling the steering system 13, brake system 18, the drive system 23, and the like, along the guidance route acquired by the route acquisition unit 38b (S126). When the guidance of the vehicle 1 is started, the actual image screen 66a and the bird's-eye view image screen 66b change in the movement situation as illustrated in FIG. 14, but the display of the tone down mode of the bird's-eye view image screen 66b and the display of the highlighting mode of the indicator N are kept. As a result, even during the guidance of the vehicle 1, the other bird's-eye-viewed vehicle Wa and the like, which includes distortion, extension, blurring, and the like is less noticeable on the bird's-eye view image screen 66b, and improvement in the recognizability of the indicator N displayed in the highlighting mode is kept. Thereby, it is possible to make the driver or the like, who visually recognizes the bird's-eye view image screen 66b during the automatic traveling, unlikely to get a feeling of strangeness.

The guidance of the vehicle 1 by the guidance control unit 38c is continuously performed until a position corresponding to the guidance reference position of the vehicle 1 (the guidance reference position G of the host vehicle icon 1a) coincides with the guidance completion position (the position corresponding to the guidance completion position T in the target region mark Nb) (No in S128). When the guidance reference position coincides with and the guidance completion position (Yes in S128), the display region changing unit 52 ends the display of the tone down mode of the bird's-eye view image screen 66b and returns to the standard image (S130). For example, the bird's-eye view image screen 66b is returned to a screen on which the first bird's-eye view image is displayed in the non-tone down mode. In another example, the bird's-eye view image screen 66b is returned to a screen on which only the actual image screen 66a is displayed, a screen on which a navigation screen or an audio screen is displayed, or the like. As a result, it becomes easy for the user to recognize that the guidance ends.

As described above, according to the periphery monitoring system 100 of this embodiment, in the bird's-eye view image on which the indicator N is superimposed, the image region based on the captured image of each imaging unit 15 is displayed in the tone down mode when the vehicle 1 is guided to the target region (target parking region). As a result, while making peripheral objects, which are included in the bird's-eye view image and have distortion, extension, blurring, and the like, less noticeable, it is possible to display the bird's-eye view image without a feeling of strangeness such as an image in which the recognizability of the peripheral objects is improved by the indicator N displayed in the highlighting mode.

When the vehicle 1 is guided through the fully automatic traveling, the actual image information such as the target region, the 3D object, and the approaching object on the bird's-eye view image is less necessary. Thus, by enhancing the tone down effect, the peripheral objects may be made much less noticeable. In contrast, when the vehicle 1 is guided through the semi-automatic traveling or the manual traveling, it may be possible to provide the sense of security to the driver if there is a possibility that the driver is able to recognize the actual image information such as the target region, the 3D object, and the approaching object on the bird's-eye view image. Therefore, when the vehicle 1 is guided through the semi-automatic traveling or the manual traveling, the tone down effect may be decreased as compared with the case of guiding through the fully automatic traveling. Even in such a case, distortion, extension, blurring, and the like of the peripheral objects can be made less noticeable as compared with the case where the tone down processing is not performed. Therefore, it is possible to provide a bird's-eye view image without a feeling of strangeness.

In the embodiment described above, the case of guiding the vehicle 1 to the target region (for example, the target parking region) through backward traveling is shown, but, for example, the same control can be applied also when guiding the vehicle 1 through forward traveling, and thus the same effect can be obtained. Further, the same control can be applied to parallel parking, side-to-side movement, and the like, and thus the same effect can be obtained.

In the embodiment described above, when the bird's-eye view image is displayed in the tone down mode, an example of performing the processing of lowering the luminance is shown, but the display of the bird's-eye view image may be toned down. For example, by increasing a permeation rate, the saturation of the bird's-eye view image may be decreased, and the same effect as the above-described embodiment can be obtained.

The program for the periphery monitoring processing executed by the CPU 14a of this embodiment may be configured to be recorded and provided as a file in an installable format or an executable format, in a computer readable recording medium such as a CD-ROM, a flexible disk (FD), a CD-R, or a digital versatile disk (DVD).

The periphery monitoring processing program may be configured to be stored in a computer connected to a network such as the Internet and provided by being downloaded through the network. Further, the periphery monitoring processing program to be executed in this embodiment may be provided or distributed through a network such as the Internet.

A periphery monitoring device according to an aspect of this disclosure includes, for example, a bird's-eye view image generation unit that generates a bird's-eye view image from a captured image obtained by imaging a periphery of a vehicle; an indicator control unit that superimposes at least one indicator of a target region indicator indicating a target region to which the vehicle is able to move, a 3D object indicator indicating a 3D object present around the vehicle, and an approaching object indicator indicating an approaching object approaching the vehicle, on the bird's-eye view image in a highlighting mode; and a display adjustment unit that displays an image region based on the captured image in the bird's-eye view image on which the indicator is superimposed with at least one of a luminance value and a saturation being reduced when the vehicle is guided to the target region. According to this aspect, for example, when the vehicle is guided to the target region, the image region based on the captured image in the bird's-eye view image is displayed in a mode in which the luminance value and the saturation are decreased. Thus, for example, a target region, a 3D object, an approaching object, and the like, which are present around the host vehicle that is distorted, extended, or blurred on the bird's-eye view image, become less noticeable. As a result, it is possible to reduce the feeling of strangeness in the bird's-eye view image. On the other hand, since the target region, the 3D object, the approaching object, and the like are displayed in a highlighting mode by the indicator, it becomes easy to detect the existence and the relative positional relationship of the host vehicle and the target region, the 3D object, the approaching object, and the like which are indicated by the indicator. As a result, it is possible to easily detect (perform the periphery monitoring on) the situation around the host vehicle in the bird's-eye view.

The bird's-eye view image generation unit of the periphery monitoring device according to the aspect of this disclosure may change, for example, an area of a display region of the bird's-eye view image between a first bird's-eye view display region of a predetermined range centered on the vehicle and a second bird's-eye view display region wider than the first bird's-eye view display region in accordance with a processing step for executing periphery monitoring of the vehicle. According to this configuration, for example, a bird's-eye view image is presented in a display range including the target region, the 3D object, the approaching object, and the like that the user is desired to recognize at the time of periphery monitoring. As a result, it is possible to easily detect (perform periphery monitoring on) the situation around the host vehicle in the bird's-eye view.

The display adjustment unit of the periphery monitoring device according to the aspect of this disclosure may execute, for example, display processing of decreasing a luminance value of the bird's-eye view image when the luminance value is equal to or greater than a predetermined value. According to this configuration, for example, when the periphery around the host vehicle is originally dark and distortion, extension, blurring, and the like of the target region, the 3D object, the approaching object, and the like are less noticeable, it is possible to prevent the bird's-eye view image from being darkened more than necessary. As a result, it is possible to easily detect (perform periphery monitoring on) the situation around the host vehicle in the bird's-eye view.

The display adjustment unit of the periphery monitoring device according to the aspect of this disclosure may execute, for example, display processing of decreasing the luminance value such that an average luminance value of the bird's-eye view image becomes a predetermined target luminance value. According to this configuration, for example, it is possible to make the decrease in luminance value of the bird's-eye view image substantially constant. In addition, regardless of the brightness around the vehicle (for example, regardless of day and night, indoors and outdoors, and the like), it is possible to display the bird's-eye-view image with the luminance value of the same viewing method decreased. As a result, it is possible to easily detect (perform periphery monitoring on) the situation around the host vehicle in the bird's-eye view.

The display adjustment unit of the periphery monitoring device according to the aspect of this disclosure may execute, for example, display processing of decreasing the luminance value of the bird's-eye view image using a predetermined constant value. According to this aspect, for example, regardless of the brightness around the vehicle, it becomes possible to clarify the change in luminance before and after the display processing, and it is possible to cause the user to easily recognize that the processing of decreasing the luminance value is executed. As a result, it becomes easy to realize that it is easy to detect (perform periphery monitoring on) the situation around the host vehicle in the bird's-eye view.

The display adjustment unit of the periphery monitoring device according to the aspect of this disclosure may decrease, for example, a luminance value of the image region based on the captured image, and does not decrease the luminance value of the at least one indicator of the target region indicator, the 3D object indicator, and the approaching object indicator. According to this configuration, for example, it becomes possible to maintain the visibility of the indicator. As a result, it becomes easy to realize that it is easy to detect (perform periphery monitoring on) the situation around the host vehicle in the bird's-eye view.

When the guidance of the vehicle to the target region ends, the display adjustment unit of the periphery monitoring device according to the aspect of this disclosure may restore, for example, the luminance value or the saturation, which is decreased at the time of the guidance, in the image region. According to this configuration, it is easy for the user to recognize that the guidance ends.

The embodiments and modification examples of this disclosure have been described, but these embodiments and modification examples are presented as examples and are not intended to limit the scope of the disclosure. These novel embodiments can be implemented in various other forms, and various omissions, substitutions, and modifications can be made without departing from the scope of the disclosure. These embodiments and modifications thereof are included in the scope and the gist of the disclosure, and are included in the disclosure described in the claims and the equivalent scope thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A periphery monitoring device comprising:
a bird's-eye view image generation unit that generates a bird's-eye view image from a captured image obtained by imaging a periphery of a vehicle;
an indicator control unit that superimposes at least one indicator of a target region indicator indicating a target region to which the vehicle is able to move, a 3D object indicator indicating a 3D object present around the vehicle, and an approaching object indicator indicating an approaching object approaching the vehicle, on the bird's-eye view image in a highlighting mode; and
a display adjustment unit that displays an image region based on the captured image in the bird's-eye view image on which the indicator is superimposed with at least one of a luminance value and a saturation being reduced when the vehicle is guided to the target region.

2. The periphery monitoring device according to claim 1, wherein
the bird's-eye view image generation unit changes an area of a display region of the bird's-eye view image between a first bird's-eye view display region of a predetermined range centered on the vehicle and a second bird's-eye view display region wider than the first bird's-eye view display region in accordance with a processing step for executing periphery monitoring of the vehicle.

3. The periphery monitoring device according to claim 1, wherein
the display adjustment unit executes display processing of decreasing a luminance value of the bird's-eye view image when the luminance value is equal to or greater than a predetermined value.

4. The periphery monitoring device according to claim 3, wherein
the display adjustment unit executes display processing of decreasing the luminance value such that an average luminance value of the bird's-eye view image becomes a predetermined target luminance value.

5. The periphery monitoring device according to claim 3, wherein
the display adjustment unit executes display processing of decreasing the luminance value of the bird's-eye view image using a predetermined constant value.

6. The periphery monitoring device according to claim 1, wherein
the display adjustment unit decreases a luminance value of the image region based on the captured image, and does not decrease the luminance value of the at least one indicator of the target region indicator, the 3D object indicator and the approaching object indicator.

7. The periphery monitoring device according to claim 1, wherein
when the guidance of the vehicle to the target region ends, the display adjustment unit restores the luminance value or the saturation, which is decreased at the time of the guidance, in the image region.
